(19) United States
(12) Patent Application Publication
(10) Pub. No.: US 2018/0125073 A1
(43) Pub. Date: May 10, 2018

(54) PESTICIDAL COMPOSITIONS AND RELATED METHODS

(71) Applicant: Dow AgroSciences LLC, Indianapolis, IN (US)

(72) Inventors: Miriam BURKHART, Indianapolis, IN (US); Luis E. GOMEZ, Carmel, IN (US); Lei LIU, Carmel, IN (US); Mary RUSHTON, Indianapolis, IN (US); Christopher WAID, Carmel, IN (US); Dan WU, Indianapolis, IN (US)

(21) Appl. No.: 15/563,929

(22) PCT Filed: Mar. 30, 2016
(86) PCT No.: PCT/US16/25095

§ 371 Date: Oct. 2, 2017

Related U.S. Application Data
(60) Provisional application No. 62/141,131, filed on Mar. 31, 2015.

(51) Int. Cl. A01N 47/40; A01N 25/30

(52) U.S. Cl. CPC A01N 47/40; A01N 25/30

(57) ABSTRACT

A pesticidal composition comprises at least one nonionic surfactant and an active ingredient group alpha (AIGA) compound at the weight ratio of nonionic surfactant to AIGA compound of at least about 20:1. The pesticidal composition shows an enhanced residue activity of the AIGA compound in soil. A method of controlling a sap-feeding insect on a top part of the plant comprises applying a pesticidally effective amount of such pesticidal composition to soil around a root system of the plant. A method of controlling pests comprises applying a pesticidally effective amount of such pesticidal composition to at least one of: soil, seed of a plant, a portion of a plant, and locus where control of pests is desired.

### PRIORITY CLAIM

This application is a national phase entry under 35 U.S.C. § 371 of international Patent Application PCT/US2016/025095 filed on Mar. 30, 2016, which claims the benefit of the filing date of U.S. Provisional Patent Application Ser. No. 62/141,131, filed Mar. 31, 2015, which is incorporated herein in its entirety.

### TECHNICAL FIELD OF THE DISCLOSURE

Various embodiments relate generally to pesticidal compositions and to methods of using such pesticidal compositions in controlling pests.

### BACKGROUND

Controlling pest population is essential to modern agriculture, food storage, and hygiene. Currently, safer and effective encapsulated pesticide formulations play a significant role in controlling pest populations. Unfortunately, most pesticide formulations, especially liquid based formulations, lose their efficacy relatively soon after application. Such pesticide formulations must, therefore, be reapplied to ensure pest control. Additionally, formulations with a short period of post application activity may result in periods of time during which an area is vulnerable to infestation by pests.

### BRIEF DESCRIPTION OF THE FIGURES

FIG. 1 is a graph showing % sulfoxaflor recovery in the inoculated Midwest soil after three days for non-limiting examples of the pesticidal compositions;

FIG. 2 is a graph showing % sulfoxaflor recovery after three days for the pesticidal compositions having different amounts of polyglycoside AGNIQUE® PG 8107 surfactant, which is C8-C10 alkyl polyglycoside with degree of polymer of 1.7;

FIG. 3 is a graph showing % sulfoxaflor recovery after three days for the pesticidal compositions having different amounts of ethoxylated alcohol AGNIQUE® FOH TDA-9 surfactant, which is PEG-9 tridecyl alcohol ether;

FIG. 4 is a graph showing % sulfoxaflor recovery after three days for the pesticidal compositions having different amounts of sulfoxaflor;

FIG. 5 is a graph showing % sulfoxaflor recovery at different time intervals after soil application for the pesticidal compositions having different types of nonionic surfactants: polyglycoside AGNIQUE® PG 8107 surfactant, which is C8-C10 alkyl polyglycoside with degree of polymer of 1.7, and ethoxylated alcohol MAKON® TD3, which is PEG-3 tridecyl alcohol ether;

FIG. 6 is a graph showing a comparative effect of different antifoaming agents on the % sulfoxaflor recovery;

FIG. 7 is a graph showing numbers of live green peach aphids (Myzus persicae) at 21 days after the soil treatment using different compositions; and

FIG. 8 is a graph showing numbers of live green peach aphids (Myzus persicae) at 28 days after the soil treatment using different compositions.

### DETAILED DESCRIPTION

As used herein, the term “pest” means and includes invertebrates, organisms and microorganisms (including pathogens) that negatively affect plants or animals. This includes organisms that spread disease and/or damage the host and/or compete for host nutrients. In addition, plant pests are organisms known to associate with plants and which, as a result of that association, cause a detrimental effect on the health and vigor of plants. Plant pests include but are not limited to fungi, bacteria, insects, arachnids, nematodes, slugs, snails, etc.

The term “pesticide,” as used herein, means and includes any substance that may be used to control agricultural, natural, environmental, and domestic/household pests, such as insects, fungi, bacteria, and viruses.

The terms “control” and “controlling,” as used herein, mean and include killing, eradication, arresting in growth, inhibition, reducing in number and/or imparting sterility.

The term “insecticide,” as used herein, refers to a specific category of pesticides used for controlling insects.

The term “active ingredient,” as used herein, means and includes a material having activity useful in controlling pests, and/or that is useful in helping other materials have better activity in controlling pests, examples of such materials include, but are not limited to, acaricides, algicides, avicides, bactericides, fungicides, herbicides, insecticides, molluscicides, nematicides, rodenticides, virucides, antifeedants, bird repellents, chemosterilants, herbicide safeners, insect attractants, insect repellents, mammal repellents, mating disrupters, plant activators, plant growth regulators, and synergists. Specific examples of such materials may include, but are not limited to, the materials listed in the active ingredient group alpha. Active ingredient group alpha compound has a short soil half-life, and therefore, its soil stability may be improved using the technology described herein.

The term “active ingredient group alpha” (hereafter “AIGA”), as used herein, means and includes collectively the following materials:

(1) Insecticides—acephate, acetamiprid, aldicarb, aldoxycarb, bendiocarb, butocarboxim, carbaryl, cartap hydrochloride, demeton-S-methyl, dimethoate, flonicamid, formothion, heptenophos, imidacloprid, isazofos, methamidophos, methomyl, monocrotophos, nitenpyram, omethoate, oxamyl, oxydemeton-methyl, phorate, sulfoxaflor (preferred), thiacloprid, thiamethoxam, thiocyclam hydrogen oxalate, thiometon, thiometon sulfone, triazamate, and vamidothion;

(2) Fungicides—carboxin, cymoxanil, dodine, ethirimol, fosetyl-aluminum, fuberidazole, hymexazol, iprobenfos, metalaxyl, metalaxyl-M, metsulfovax, ofurace, oxycarboxin, propamocarb hydrochloride, pyroquilon, and triadimefon.

The term “initial soil,” as used herein, means soil in its original state without adding anything to it.

The term “initial soil moisture,” as used herein, means an amount of water in the soil, as described by a weight percent.

The term “dry soil mass,” as used herein, means a total mass of the dry soil particles without any moisture (as if all of the moisture had evaporated out of it). The dry soil mass may be determined using the following equation:

Dry Soil Mass=Initial Soil Mass−(Initial Soil Mass×Moisture Content %)

The term “final soil mixture,” as used herein, means the soil mass after addition of the pesticidal formulation, which may include sulfoxaflor solution, surfactant/adjuvant solution, and/or additional water, to the initial soil.

The term “total soil liquid,” as used herein, means a total amount of liquid in soil including the initial soil moisture and the added pesticidal formulation, which may include sulfoxaflor solution, surfactant/adjuvant solution, and/or additional water. The total soil liquid may be determined using the following equation:

Total Soil Liquid=(Initial Soil Mass×Moisture Content %)+Mass of Pesticidal Formulation

The term “ppm,” as used herein, stands for part-per-million, and refers to the amount of a component of interest in micrograms (μg) per one gram of soil sample.

The term “sulfoxaflor concentrate,” as used herein, refers to a sulfoxaflor concentrate at a sulfoxaflor concentration of 240 grams per liter (g/L) (such as the CLOSER® SC insecticide available from Dow AgroSciences) or a sulfoxaflor concentrate at a sulfoxaflor concentration of 500 grams per kilogram (g/kg) (such as the TRANSFORM® WG insecticide also available from Dow AgroSciences). The sulfoxaflor concentrate may be in the form of an aqueous suspension concentrate formulation (SC), a water dispersible granule formulation (WDG), an oil dispersion formulation (OD), or a suspension emulsion formulation (SE).

As used herein, the term “sulfoxaflor” is the provisionally approved name for [methyl(oxo) {1-[6-(trifluoromethyl)-3-pyridyl]ethyl}-λ⁶-sulfanylidene]cyanamide, which is also known as N-[methyloxido[1-[6-(trifluoromethyl)-3-pyridinyl]ethyl]λ⁴-sulfanylidene]cyanamide (CAS Name, CAS registry number 946578-00-3). Sulfoxaflor is a mixture of four possible stereoisomers, the chemical structures of which are as follows:

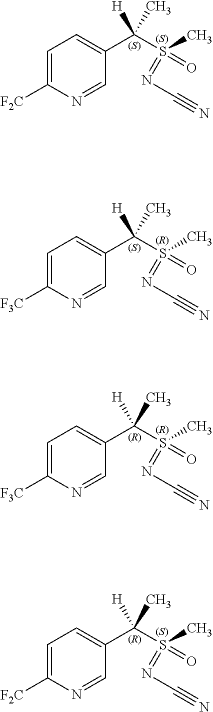

Sulfoxaflor demonstrates efficacy against a broad spectrum of pests. Sulfoxaflor has demonstrated excellent acute efficacy against a broad spectrum of sap-feeding insects like aphids. Sulfoxaflor has also been shown to have a high level of efficacy against hard to control true bugs, such as Lygus. Additionally, sulfoxaflor possesses high levels of intrinsic activity and controls insect populations resistant to neonicotinoid and other insecticide modes of action including the organophosphates, pyrethroids, and carbamates. For example, foliar application of sulfoxaflor has demonstrated efficacy under field conditions that is equal or superior to neonicotinoid compounds at equivalent or lower use rates, particularly for aphid control.

However, the residual activity of sulfoxaflor in soil applications is relatively less than desirable because sulfoxaflor degrades very rapidly in soil. The degradation of pesticides in soil may be defined by half-life DT₅₀ value. Half-life DT₅₀ is an amount of time taken for 50% of the pesticide to disappear from soil by degradation. The degradation processes may be biological processes (biodegradation) or physicochemical processes (hydrolysis, photolysis, etc.). The pesticide having half-life DT₅₀ value of less than 20 days is readily degradable in soil.

The average half-life DT₅₀ of sulfoxaflor in laboratory soil metabolism studies, conducted in the dark, was less than one day. Degradation was also rapid under field conditions, with an average half-life DT₅₀ of four days in field dissipation studies. Improving stability of sulfoxaflor in soil would extend the sulfoxaflor soil half-life making it available for plant uptake to control sap-feeding insects on the top part of the plant for longer periods of time. Therefore, the sulfoxaflor pesticidal composition with improved soil stability is desirable in order to increase the lifetime of sulfoxaflor in soil and to slow the rate of loss due to degradation.

In one particular embodiment, the pesticidal composition comprises at least one nonionic surfactant and an active ingredient group alpha (AIGA) compound, wherein the weight ratio of nonionic surfactant to AIGA compound is at least about 20:1, and particularly at least about 25:1.

The pesticidal composition includes a unique combination of nonionic surfactant and AIGA compound at a selected weight ratio. The pesticidal composition increases the soil half-life of AIGA compound, while maintaining (if not enhancing) the pesticidal activities of AIGA compound.

In some embodiments, the pesticidal composition comprises at least one nonionic surfactant and an AIGA compound, wherein the weight ratio of nonionic surfactant to AIGA compound is between about 100:1 and about 20:1, more particularly between about 100:1 and about 30:1, and still more particularly between about 100:1 and about 40:1.

In some embodiments, the pesticidal composition comprises at least one nonionic surfactant and an AIGA compound, wherein the weight ratio of nonionic surfactant to AIGA compound is between about 65:1 and about 20:1, more particularly between about 65:1 and about 25:1, and still more particularly between about 65:1 and about 30:1.

In some embodiments, the pesticidal composition comprises at least one nonionic surfactant and an AIGA compound, wherein the weight ratio of nonionic surfactant to AIGA compound is between about 50:1 and about 20:1, more particularly between about 50:1 and about 25:1, and still more particularly between about 50:1 and about 30:1.

In some further embodiments, the pesticidal composition comprises at least one nonionic surfactant and an AIGA compound, wherein the weight ratio of nonionic surfactant to AIGA compound is between about 40:1 and about 20:1, and more particularly between about 40:1 and about 30:1.

In yet further embodiments, the pesticidal composition comprises at least one nonionic surfactant and an AIGA compound, wherein the weight ratio of nonionic surfactant to AIGA compound is between about 30:1 and about 20:1, and more particularly between about 30:1 and about 25:1.

The AIGA compound may include collectively the following materials: (1) an insecticide comprising acephate, acetamiprid, aldicarb, aldoxycarb, bendiocarb, butocarboxim, carbaryl, cartap hydrochloride, demeton-S-methyl, dimethoate, flonicamid, formothion, heptenophos, imidacloprid, isazofos, methamidophos, methomyl, monocrotophos, nitenpyram, omethoate, oxamyl, oxydemeton-methyl, phorate, sulfoxaflor (preferred), thiacloprid, thiamethoxam, thiocyclam hydrogen oxalate, thiometon, thiometon sulfone, triazamate, vamidothion, or mixtures thereof; (2) a fungicide comprising carboxin, cymoxanil, dodine, ethirimol, fosetyl-aluminum, fuberidazole, hymexazol, iprobenfos, metalaxyl, metalaxyl-M, metsulfovax, ofurace, oxycarboxin, propamocarb hydrochloride, pyroquilon, triadimefon, or mixtures thereof; or a mixture of (1) and (2).

In one particular embodiment, the AIGA compound in the pesticidal composition comprises sulfoxaflor. Thus, the pesticidal composition may comprise at least one nonionic surfactant and sulfoxaflor, wherein the weight ratio of nonionic surfactant to sulfoxaflor is at least about 20:1, and particularly at least about 25:1. In some embodiments, the weight ratio of nonionic surfactant to sulfoxaflor is between about 100:1 and about 20:1, more particularly between about 100:1 and about 30:1, and still more particularly between about 100:1 and about 40:1.

Nonionic surfactants may include, but are not limited to, ethoxylate surfactants, polyglycoside surfactants, polysorbate surfactants, polymeric surfactants such as polyethylene oxide-polypropylene oxide (PEO-PPO) block copolymer, siloxane alkoxylate surfactants, sucrose ester surfactants, glycol ester surfactants, glycerol ester surfactants, polyglycerol ester surfactants, or glucoside surfactants.

Non-limiting examples of ethoxylate surfactants may include, but are not limited to, alcohol ethoxylates, alkyl phenol ethoxylates, fatty acid ethoxylates, monoalkanolamide ethoxylates, sorbitan ester ethoxylates, or fatty amine ethoxylates.

The alcohol ethoxylate surfactants may include, but are not limited to, PEO C6-C12 alcohol, PEO C9-C12 alcohol, PEO C12-C15 alcohol, PEO C16-C18 alcohol, PEO lauryl alcohol, PEO oleyl alcohol, PEO stearyl alcohol, PEO isodecylalcohol, and PEO tridecylalcohol. By way of non-limiting examples, the alcohol ethoxylate surfactants may include, but are not limited to, BIO-SOFT® N25-7 (POE (7) C12-C15 alcohol, HLB 12.2) from Stepan Company; BIO-SOFT® N, EN and E series from Stepan Company; MAKON® DA and TD series from Stepan Company; BRIJ® 35, 56 and 78 series, ATLOX® MBA 11/6, 13/5 and 13/20 series, RENEX® 30, 31 and 36 series, and SYNPERONIC® A3, A5, Al 1, 91/4 and 91/10 series from Uniqema; GENAPOL® LA and 0 series from Clariant Corporation; AGNIQUE® FOH series from Cognis Corporation; ETHYLAN® OX 91-8, SN 70, 1204, 048, and 087 series from Akzo Nobel N.V.; or RHODASURF™ DA-530, DA-630, L-4 series and RHODASURF™ BC series from Rhodia, Inc.

Non-limiting examples of polyglycoside surfactants may include, but are not limited to, alkyl polyglycosides. Non-limiting examples of alkyl polyglycoside surfactants may include, but not limited to, AGNIQUE® PG 8105, AGNIQUE® PG 8107, AGNIQUE® PG 8166, AGNIQUE® PG 9166, and AGNIQUE® PG 266 from Cognis Corporation; Triton™ BG-IO and CG-110 from The Dow Chemical Company; or ATPLUS® 438 and 452 from Uniqema.

Polysorbate surfactant may be alkyl PEO sorbitan esters or PEO sorbitan esters of fatty acids. Non-limiting examples of ethoxylated sorbitan esters of fatty acids may include, but not limited to, PEO (20) sorbitan monotallate surfactant such as AGNIQUE® SMO 20-U surfactant (HLB 15) available from Cognis Corporation. Other suitable PEO sorbitan esters may include, but are not limited to, AGNIQUE® SML, SMS, STS and other SMO products from Cognis Corporation; ARMOTAN® SMO 20 from Akzo Nobel N.V.; TOXIMUL® SEE-340 and 341 from Stepan Company; ALTOX® 80 and 8916TF from Uniqema; or TWEEN® 20, 40, 60, 65, 80, 81 and 85 series from Uniqema.

The polymeric surfactants may be homopolymer surfactants, block copolymer surfactants, random polymer surfactants, or mixture thereof. Non-limiting examples of homopolymer surfactants may include, but are not limited to, polyethylene oxide (PEO) surfactants, PEO alkylphenols, PEO fatty acid esters, PEO fatty amines, alkylpolysaccharides, or polyvinylpyrrolidone surfactant such as AGRIMER 15, 30 and 60 from International Specialty Products. Non-limiting examples of block copolymer surfactants may include, but are not limited to, ethylene oxide-propylene oxide (EO-PO) copolymers, or polyoxyalkylene polyarylethers.

The PEO surfactants may include, but not limited to, AGNIQUE® CSO-40 (PEO (40) castor oil, HLB 13) from Cognis Corporation; AGNIQUE® CSO-30 (PEO (30) castor oil, HLB 11.8) from Cognis Corporation; AGNIQUE® CSO-16 (PEO (16) castor oil, HLB 8.6) from Cognis Corporation; AGNIQUE® SBO, RSO and CSO surfactants from Cognis Corporation; NINEX® MT-603, MT-610 and MT-615 from Stepan Company; TOXIMUL® 8240, 8241, 8243 and 8244 from Stepan Company; EMULPON® CO 200, 904 and 360 from Akzo Nobel N.V.; EMULSOGEN® EL 360, EL-400, EL-719 and HCO-040 from Clariant Corporation; or ALKAMULS® EL-620, OR-40 and EL-719 from Rhodia, Inc.

The PEO alkylphenol surfactants may include, but are not limited to, PEO nonylphenol, PEO octylphenol, PEO tributylphenol, PEO dinonylphenol, or PEO dodecylphenol. By way of non-limiting examples, the PEO alkylphenol surfactants may include, but are not limited to, MAKON® 4 (POE (4) nonylphenol, HLB 9) and MAKON® 8 (POE (8) nonylphenol, HLB 12) from Stepan Company; MAKON® 10, 12, 14 and 30 series, and MAKON® OP-9 from Stepan Company; SYNPERONIC® NP series from Uniqema; ARKOPAL® N series, EMULSOGEN® 10, and SAPOGENAT® T040, T060, T080 and T110 series from Clariant Corporation; AGNIQUE® NP and OP series from Cognis Corporation; WITCONOL® NP series from Akzo Nobel N.V.; or IGEPAL™ CO, CA, DM and RC series from Rhodia, Inc.

The PEO fatty acid ester surfactants may include, but not limited to, PEO dioleate, PEO monolaurate, PEO monooleate, PEO dioleate, PEO monostearate, PEO coconut oil fatty acid ester, or PEO tall oil fatty acid ester. By way of non-limiting examples, the PEO fatty acid ester surfactants may include, but are not limited to, AGNIQUE® PEG 600ML (POE monolaurate with approximate POE molecular weight of 600, HLB 14.8) from Cognis Corporation; AGNIQUE® 200 MO, 400 MO, 400 MS and 660 MS from Cognis Corporation; MYRJ® 45, 49, 51 and 53 from Uniqema; MAPEG® 200 ML, 400 DO, 400 MO, 400 MOT and 600 MS from BASF Corporation; or STEPAN® PEG series from Stepan Company.

The PEO fatty amine surfactants may include, but not limited to, PEO tallow amine, PEO cocoamine, PEO oleylamine, or PEO stearyl amine. Non-limiting examples of PEO fatty amine surfactants may include, but not limited to, TOXIMUL® TA-2, TA-5, TA-8, TA-IO and TA-15 from Stepan Company; AGNIQUE® CAM-2, CAM-IO, CAM-15, CAM-20, OAM-30, TAM-IO, TAM-15, TAM-20, TAM-40 and SAM-50 from Cognis Corporation; or RHODAMEEN™ PN-430 and RHODAMEEN™ TA-15 from Rhodia, Inc.

The EO-PO block polymer surfactants may include, but are not limited to, block copolymers of ethylene oxide and propylene oxide, EO-PO alkylphenol block polymers, EO-PO butanol block polymers (polyoxyethylene-polyoxypropylene monobutyl ether), or EO-PO ethylenediamine block polymers. By way of non-limiting examples, the EO-PO block polymer surfactants may include, but are not limited to, PLURONIC® L92 (block copolymer of ethylene oxide and propylene oxide, average molecular weight 3650, HLB 6) from BASF Corporation; PLURONIC® L and P series from BASF Corporation; TOXIMUL® 8320 and 8323 from Stepan Company; ATLAS® G-5000 and SYNPERONIC® PE series from Uniqema; AGNIQUE® BP 4-3103 and BP NP-1530 from Cognis Corporation; ETHYLAN® NS 500 K and NS 500 LQ from Akzo Nobel N.V.; TERGITOL™ XD, XH, XJ series from The Dow Chemical Company; or ANTAROX™ 724/P, SC/167, F-108 and P-104 from Rhodia, Inc.

The polyoxyalkylene polyarylether surfactants may include, but are not limited to, polyethylene oxide (PEO) polypropylene oxide (PPO) tristyrylphenols, or PEO tristyrylphenols. By way of non-limiting examples, the polyoxyalkylene polyarylether surfactants may include, but are not limited to, SOPROPHOR® 796/P (POE (21)/POP (4) tristyrylphenol, HLB 13.5) from Rhodia; EMULSOGEN® TS 160 from Clariant Corporation; AGNIQUE® TSP 16 from Cognis Corporation; or SOPROPHOR® BSU and CY/8 from Rhodia.

The pesticidal composition may include a solvent. Non-limiting examples of suitable solvents may include, but are not limited to, acetone and other ketones, alcohols, esters, aromatic hydrocarbons, aliphatic hydrocarbons, ethers, water, or mixtures thereof.

The pesticidal composition may further include at least one inert ingredient. The optional inert ingredient may be any material commonly used in the art of pesticidal formulation as described, inter alia, in “McCutcheon's Detergents and Emulsifiers Annual,” MC Publishing Corp., Ridgewood, N.J., 1998 and in the “Encyclopedia of Surfactants,” Vol. I-III, Chemical Publishing Co., New York, 1980-81.

In some embodiments, the pesticidal composition may further include at least one additive that allows the pesticidal composition to be at the required concentration and in an appropriate form, permits ease of application and handling, offers ease and stability during transportation and storage, and/or provides enhanced pesticide activity. By way of non-limiting examples, the additive may include, but are not limited to, an antifoaming agent, antioxidant, a dispersant, a thickener, a preservative, a pH buffer, an antifreezing agent, or a diluent.

Any known antifoaming agents may be used. Non-limiting examples of antifoaming agents may be polydialkylsiloxane (e.g., polydimethylsiloxane), hydrocarbon oil, tetramethydecynediol, or dimethyloctynediol.

Non-limiting examples of antioxidants may include, but are not limited to, alkyl phenol (e.g., butylated hydroxytoluene or anisole), alkyl gallate, ascorbic acid, or tocopherol.

By way of examples and not limitation, the dispersants may include, but are not limited to, a blend of an alkyl naphthalene sulfonate condensate and lignosulfonate, such as MORWET® D-360 powder from Akzo Nobel N.V.

Any known thickeners may be used. Non-limiting examples of thickeners may include, but are not limited to, a microcrystalline cellulose gel such as AVICEL® CL 611 thickener from FMC Corporation (Philadelphia, Pa.), or an organic gum such as KELZAN® S xanthan gum from CP Kelco U.S., Inc. (Atlanta, Ga.), or both.

The pesticidal composition may optionally include at least one preservative. By way of non-limiting example, the preservative may be an aqueous solution of 1,2-benzisothiazolin-3-one, such as PROXEL® GXL preservative from Arch UK Biocides Limited (England).

Non-limiting examples of pH buffer may include, but are not limited to, an aqueous solution of a weak acid and its conjugate base, or a weak base and its conjugate acid such as, for example, citric acid, ascorbic acid, potassium phosphate or sodium phosphate. The buffer solution may be formulated to maintain a desired pH of about 2 to about 6, particularly a pH of about 2 to about 4 of the pesticidal composition.

Suitable antifreezing agents may include, but are not limited to, propylene glycol, ethylene glycol and glycerol, and mixtures thereof.

In some embodiments, the pesticidal composition may further include an adjuvant surfactant to enhance deposition, wetting and/or penetration of the pesticidal composition onto the target soil, crop, or organism. These optional adjuvant surfactants may be employed as one component of the pesticidal composition during the preparation of pesticidal composition. Alternatively, these optional adjuvant surfactants may be mixed (e.g., tank mixed) with the pesticidal composition after the pesticidal composition is prepared. The amount of adjuvant surfactant may vary from about 0.01% to about 1% by volume, based on a spray-volume of water, preferably from about 0.05% to about 0.5% volume. Suitable adjuvant surfactants may include, but are not limited to, ethoxylated nonyl phenols, ethoxylated synthetic or natural alcohols, salts of the esters or sulfosuccinic acids, ethoxylated organosilicones, ethoxylated fatty amines, or blends of surfactants with mineral or vegetable oils.

The pesticidal composition may be prepared by mixing at least one nonionic surfactant and an AIGA compound at a predetermined weight ratio of nonionic surfactant to AIGA compound, in at least one solvent to form a base formulation. Then, other ingredients may be mixed with the base formulation to form the pesticidal composition. Alternatively, the pesticidal composition may be prepared by mixing at least one nonionic surfactant, an AIGA compound, and other ingredients in at least one solvent.

In one particular embodiment, the pesticidal composition is prepared by first producing a sulfoxaflor concentrate having a sulfoxaflor concentration of 240 g/L or 500 g/kg, and then mixing (e.g., tank mixing) at least one nonionic surfactant with the sulfoxaflor concentrate.

Accordingly, in some embodiments, a method of preparing the pesticidal composition comprises mixing at least one nonionic surfactant with a sulfoxaflor concentrate, wherein the sulfoxaflor concentrate has a sulfoxaflor concentration of 240 g/L or a 500 g/kg.

The present disclosure also envisages to a method of controlling pests. The method comprises applying a pesticidally effective amount of the pesticidal composition to at least one of: soil, seed of a plant, a portion of a plant, and locus where control of pests is desired.

The present disclosure also envisages a method of controlling sap-feeding insects on the top part of plants by applying the pesticidal composition to the soil around the root system of the plant. The pesticidal composition may be applied to soil using any suitable methods that ensure the penetration of the pesticidal composition into soil. Non-limiting examples of such applications may include, but are not limited to, nursery tray application, furrow application, soil drenching, soil injection, drip irrigation, or application through sprinklers or central pivot.

Furthermore, the present disclosure envisages a method of controlling pests that comprises applying the pesticidal composition to soil. Upon applying the pesticidal composition to soil, the plant roots may absorb the pesticidal composition from soil and take it up into the foliar portions of the plant to control root and stem feeding pests such as, without limitation, above ground chewing pests and sap-feeding pests.

Furthermore, the present disclosure envisages a method of controlling pests that comprises applying the pesticidal composition to a portion of the plant. By way of non-limiting examples, control of foliar-feeding insects may be achieved by drip irrigation or furrow application, by treating the soil with for example pre- or post-planting soil drench, or by treating the seeds of a plant before planting with the pesticidal composition.

The pesticidal composition may be formulated into various forms for appropriate uses. By way of non-limiting examples, the pesticidal composition may be formulated as a concentrated emulsion, an emulsifiable concentrate, a suspension concentrate, a water soluble liquid, an ultralow volume solution, a water dispersible granule, a granule, a gel, a dry flowable and wettable powder, a dust, a tablet, a microencapsulation, a seed treatment, a bait, or a fumigant.

The pesticidal composition may be applied as a liquid formulation. By way of non-limiting examples, the liquid formulation may include, but is not limited to, water-soluble formulation, water-emulsifiable formulation, water-dispersible formulation, oil-soluble formulation, or oil-dispersible formulation.

The pesticidal composition may be applied as an aqueous suspension or emulsion prepared from a concentrated formulation of the pesticidal composition. Such water-soluble, water-dispersible, or water-emulsifiable formulation may be either solid (usually known as a wettable powder or a water dispersible granule) or liquid (usually known as an emulsifiable concentrate or an aqueous suspension).

The pesticidal composition may be applied as a wettable powder. A wettable powder, which may be compacted to form a water dispersible granule, may comprise an intimate mixture of the pesticidal composition, a carrier and, optionally, additional surfactants for facilitating the dispersion in water. Non-limiting examples of the carriers may include, but are not limited to, attapulgite clays, montmorillonite clays, diatomaceous earths, or purified silicates. By way of non-limiting examples, the optional surfactants for facilitating the dispersion in water may include, but are not limited to, sulfonated lignins, condensed naphthalenesulfonates, naphthalenesulfonates, alkylbenzenesulfonates, alkyl sulfates, or nonionic surfactants such as ethylene oxide adducts of alkyl phenols.

The pesticidal composition may be applied as an emulsifiable concentrate. An emulsifiable concentrate of the pesticidal composition may comprise the pesticidal composition, such as from about 50 to about 500 g/L of liquid dissolved in a carrier that is either a water-miscible solvent or a mixture of water-immiscible organic solvent and emulsifiers. Non-limiting examples of useful organic solvents may include, but are not limited to, aromatics such as xylenes; petroleum fractions such as the high-boiling naphthalenic; olefinic portions of petroleum such as heavy aromatic naphtha; terpenic solvents such as rosin derivatives; aliphatic ketones such as cyclohexanone; and complex alcohols such as 2-ethoxyethanol. Suitable emulsifiers for emulsifiable concentrate may be chosen from conventional anionic and nonionic surfactants.

The pesticidal composition may be applied as an aqueous dispersible formulation. An aqueous dispersible formulation may comprise a suspension of water-insoluble pesticidal composition dispersed in an aqueous carrier at a concentration in the range from about 5% to about 50% by weight. Dispersions may be prepared by finely grinding the pesticidal composition and vigorously mixing it into a carrier comprised of water and surfactants. Ingredients, such as inorganic salts and synthetic or natural gums, may also be added, to increase the density and viscosity of the aqueous carrier. It is often most effective to grind and mix the pesticidal composition at the same time by preparing the aqueous mixture and homogenizing it in an implement such as a sand mill, ball mill, or piston-type homogenizer.

The pesticidal composition may be applied as a granular formulation. A granular formulation may contain from about 0.5% to about 10% by weight of the pesticidal composition, based on the total weight of the granular formulation. The pesticidal composition may be dispersed in an inert carrier which consists entirely or in large part of coarsely divided inert material such as attapulgite, bentonite, diatomite, clay or a similar inexpensive substance. In some embodiments, a granular formulation may be prepared by diluting the pesticidal composition in a suitable solvent and applying it to a granular carrier which has been preformed to the appropriate particle size, in the range of from about 0.5 millimeters (mm) to about 3 mm. A suitable solvent is a solvent in which the pesticidal compound is substantially or completely soluble. In some embodiments, granular formulation may be prepared by making a dough or paste of the carrier, the pesticidal composition and solvent, and then crushing and drying the dough or paste to obtain the desired granular particles.

The pesticidal composition may be applied as water dispersible granule, or dry flowable formulation. A water dispersible granule may include from about 10% to about 70% by weight of the pesticidal composition, based on the total weight of the water dispersible granule. Such water dispersible granule may be obtained through mixing and/or spraying the pesticidal composition onto a carrier with the addition of a dispersing and/or wetting agent, and combining with water to form a mixture suitable for further processing using known granulation technologies, such as pan granulation, extrusion, spray-drying, fluid bed agglomeration, and the like.

The pesticidal composition may be applied as a dust. In some embodiments, dust containing the pesticidal composition may be prepared by intimately mixing the pesticidal composition with a suitable dusty agricultural carrier. Non-limiting examples of such dusty agricultural carriers may include, but are not limited to, kaolin clay, ground volcanic rock, and the like. Dusts may contain from about 1% to about 10% by weight of the pesticidal composition, based on the total weight of the dust. In some embodiments, dust may be prepared by impregnating the pesticidal composition onto a carrier in a similar manner to that described for granule above.

The pesticidal composition may be applied in the form of a solution in an appropriate organic solvent. By way of non-limiting examples, such organic solvents may include but are not limited to, petroleum oils or spray oils.

In some embodiments, the pesticidal composition may be applied in conjunction with another active formulation that comprises one or more of other insecticides or fungicides or herbicides, in order to obtain control of a wider variety of pests, diseases or weeds. Another active formulation may be one of the components used for formulating the pesticidal composition. Alternatively, another active formulation may be post-added to the pesticidal composition. Furthermore, the pesticidal composition may be applied at the same time as another active formulation, or applied sequentially with another active formulation.

Insecticides that may be employed beneficially in conjunction with the pesticidal composition may include, but are not limited to: AIGA compounds, antibiotic insecticides such as allosamidin and thuringiensin; macrocyclic lactone insecticides such as spinosad, spinetoram, and other spinosyns including the 21-butenyl spinosyns and their derivatives; avermectin insecticides such as abamectin, doramectin, emamectin, eprinomectin, ivermectin and selamectin; milbemycin insecticides such as lepimectin, milbemectin, milbemycin oxime and moxidectin; arsenical insecticides such as calcium arsenate, copper acetoarsenite, copper arsenate, lead arsenate, potassium arsenite and sodium arsenite; biological insecticides such as Bacillus popilliae, B. sphaericius, B. thurinigiensis subsp. aizqwai, B. thuringiensis subsp. kurstaki, B. thuriugiensis subsp. tenebrionis, Beauveria bassiana, Cydia pomonella granulosis virus, Douglas fir tussock moth nuclear polyhedrosis virus (NPV), gypsy moth NPV, Helicoverpa zea NPV, Indian meal moth granulosis virus, Metarhizium anisopliae, Nosema locustae, Paecilomyces fumosoroseus, P. lilacinus, Photorhabdus luminescens, Spodoptera exigua NPV, trypsin modulating oostatic factor, Xenorhabdus nematophilus, and X. bovienii; plant incorporated protectant insecticides such as Cry1Ab, Cry1Ac, Cry1F, Cry1A.105, Cry2Ab2, Cry3A, mir Cry3A, Cry3Bb1, Cry34, Cry35, and VIP3A; botanical insecticides such as anabasine, azadirachtin, d-limonene, nicotine, pyrethrins, cinerins, cinerin I, cinerin II, jasmolin I, jasmolin II, pyrethrin I, pyrethrin II, quassia, rotenone, ryania and sabadilla; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides such as dinex, dinoprop, dinosam and DNOC; fluorine insecticides such as barium hexafluorosilicate, cryolite, sodium fluoride, sodium hexafluorosilicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluoron, buprofezin, chlorfluazuron, cyromazine, diflubenzuron, flucycloxuron, flufenoxuron, hexaflumuron, lufenuron, novaluron, noviflumuron, penfluoron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists such as chromafenozide, halofenozide, methoxyfenozide and tebufenozide; moulting hormones such as alpha-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethylamine insecticides such as acetamiprid, imidacloprid, nitenpyram and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methyl sulphon, disulfoton, ethion, ethoprophos, PSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temnephos, trichlormetaphos-3 and trifenofos; phosphonate insecticides such as butonate and trichlorfon; phosphonothioate insecticides such as mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, methamidophos and propetamphos; phosphorodiamide insecticides such as dimefox, mazidox, mipafox and schradan; oxadiazine insecticides such as indoxacarb; phthalimide insecticides such as dialifos, phosmet and tetramethrin; pyrazole insecticides such as acetoprole, ethiprole, fipronil, pyrafluprole, pyriprole, tebufenpyrad, tolfenpyrad and vaniliprole; pyrethroid ester insecticides such as acrinathrin, allethrin, bioallethrin, barthrin, bifenthrin, bioethanomethrin, cyclethrin, cycloprothrin, cyfluthrin, beta-cyfluthrin, cyhalothrin, gamma-cyhalothrin, lambda-cyhalothrin, cypermethrin, alpha-cypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; tetronic acid insecticides such as spirodiclofen, spiromesifen and spirotetramat; thiourea insecticides such as diafenthiuron; urea insecticides such as flucofuron and sulcofuron; and unclassified insecticides such as AKD-3088, closantel, crotamiton, cyflumetofen, E2Y45, EXD, fenazaflor, fenazaquin, fenoxacrim, fenpyroximate, FKI-1033, flubendiamide, HGW86, hydramethylnon, IKI-2002, isoprothiolane, malonoben, metaflumizone, metoxadiazone, nifluridide, NNI-9850, NNI-0101, pymetrozine, pyridaben, pyridalyl, Qcide, rafoxanide, rynaxypyr, SYJ-159, triarathene and triazamate and any combinations thereof.

Non-limiting examples of fungicides that may be used beneficially in conjunction with the pesticidal composition may include, but are not limited to: AIGA compound, 2-(thiocyanatomethylthio)-benzothiazole, 2-phenylphenol, 8-hydroxyquinoline sulfate, Ampelomyces quisqualis, azaconazole, azoxystrobin, Bacillus subtilis, benalaxyl, benomyl, benthiavalicarb-isopropyl, benzylaminobenzene-sulfonate (BABS) salt, bicarbonates, biphenyl, bismerthiazol, bitertanol, blasticidin-S, borax, Bordeaux mixture, boscalid, bromuconazole, bupirimate, calcium polysulfide, captafol, captan, carbendazim, carboxin, carpropamid, carvone, chloroneb, chlorothalonil, chlozolinate, Coniothyrium minitans, copper hydroxide, copper octanoate, copper oxychloride, copper sulfate, copper sulfate (tribasic), cuprous oxide, cyazofamid, cyflufenamid, cymoxanil, cyproconazole, cyprodinil, dazomet, debacarb, diammonium ethylenebis-(dithiocarbamate), dichlofluanid, dichlorophen, diclocymet, diclomezine, dichloran, diethofencarb, difenoconazole, difenzoquation, diflumetorim, dimethomorph, dimoxystrobin, diniconazole, diniconazole-M, dinobuton, dinocap, diphenylamine, dithianon, dodemorph, dodemorph acetate, dodine, dodine free base, edifenphos, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fentin, fentin acetate, fentin hydroxide, ferbam, ferimzone, fluazinam, fludioxonil, flumorph, fluopicolide, fluoroimide, fluoxastrobin, fluquinconazole, flusilazole, flusulfamide, flutolanil, flutriafol, folpet, formaldehyde, fosetyl, fosetyl-aluminium, fuberidazole, furalaxyl, furametpyr, guazatine, guazatine acetates, GY-81, hexachlorobenzene, hexaconazole, hymexazol, imazalil, imazalil sulfate, imibenconazole, iminoctadine, iminoctadine triacetate, iminoctadine tris(albesilate), ipconazole, iprobenfos, iprodione, iprovalicarb, isoprothiolane, kasugamycin, kasugamycin hydrochloride hydrate, kresoxim-methyl, mancopper, mancozeb, maneb, mepanipyrim, mepronil, mercuric chloride, mercuric oxide, mercurous chloride, metalaxyl, mefenoxam, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, pefurazoate, penconazole, pencycuron, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyrazophos, pyributicarb, pyrifenox, pyrimethanil, pyroquilon, quinoclamine, quinoxyfen, quintozene, Reynoutria sachalinensis extract, silthiofam, simeconazole, sodium 2-phenylphenoxide, sodium bicarbonate, sodium pentachlorophenoxide, spiroxamine, sulfur, SYP-Z071, tar oils, tebuconazole, tecnazene, tetraconazole, thiabendazole, thifluzamide, thiophanate-methyl, thiram, tiadinil, tolclofos-methyl, tolylfluanid, triadimefon, triadimenol, triazoxide, tricyclazole, tridemorph, trifloxystrobin, triflumizole, triforine, triticonazole, validamycin, vinclozolin, zineb, ziram, zoxamide, Candida oleophila, Fusarium oxysporum, Gliocladium spp., Phlebiopsis gigantean, Streptomyces griseoviridis, Trichoderma spp., (RS)—N-(3,5-dichlorophenyl)-2-(methoxymethyl)-succinimide, 1,2-dichloropropane, 1,3-dichloro-1,1,3,3-tetrafluoroacetone hydrate, 1-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme: ampropylfos, anilazine, azithiram, barium polysulfide, Bayer 32394, benodanil, benquinox, bentaluron, benzamacril; benzamacril-isobutyl, benzamorf, binapacryl, bis(methylmercury) sulfate, bis(tributyltin) oxide, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, furcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, phenylmercury nitrate, phosdiphen, prothiocarb; prothiocarb hydrochloride, pyracarbolid, pyridinitril, pyroxychlor, pyroxyfur, quinacetol; quinacetol sulfate, quinazamid, quinconazole, rabenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, urbacid, XRD-563, and zarilamid, and any combinations thereof.

Herbicides that may be employed in conjunction with the pesticidal composition may include, but are not limited to: amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchior, thenylchlor and xylachlor; sulfonanilide herbicides such as benzofluor, perfluidone, pyrimisulfan and profluazol; sulfonamide herbicides such as asulam, carbasulam, fenasulam and oryzalin; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as mesotrione, sulcotrione, tefuryltrione and tembotrione; benzofuranyl alkylsulfonate herbicides such as benfuresate and ethofumesate; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as benzfendizone, cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrile herbicides such as bromobonil, bromoxynil, chloroxynil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glyphosate and piperophos; phenoxy herbicides such as bromofenoxim, clomeprop, 2,4-DEB, 2,4-DEP, difenopenten, disul, erbon, etnipromid, fenteracol and trifopsime; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazolyl herbicides such as benzofenap, pyrazolynate, pyrasulfotole, pyrazoxyfen, pyroxasulfone and topramezone; pyrazolyiplpiethyl herbicides such as fluazolate and pyraflufen; pyridamine herbicides such as credazine, pyridafol and pyridate; pyridazitiotte herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluoroxypyr, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron and metribuzin; triazole herbicides such as amitrole, cafenstrole, epronaz and flupoxam; triazolone herbicides such as amicarbazone, bencarbazone, carfentrazone, flucarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as butafenacil, bromacil, flupropacil, isocil, lenacil and terbacil; 3-phenyluracils; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluoron, phenobenzuron, siduron, tetrafluoron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluoron and thidiazuron; and unclassified herbicides such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, fluorochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac.

The pesticidal composition may be used for controlling a variety of pests.

In a particular embodiment, the pesticidal composition may be used to control pests in the Phyla Nematoda and/or Arthropoda. In another embodiment, the pesticidal composition may be used to control pests in the Subphyla Chelicerata, Myriapoda, and/or Hexapoda. In yet another embodiment, the pesticidal composition may be used to control pests in the Classes of Arachnida, Symphyla, and/or Insecta. In an alternate embodiment, the pesticidal composition may be used to control pests of the Order Homoptera.

In another embodiment, the pesticidal composition may be used to control pests of the Order Anoplura. Non-limiting examples of genera may include, but are not limited to, Haematopinus spp., Hoplopleura spp., Linognathus spp., Pediculus spp., and Polyplax spp. Non-limiting examples of species may include, but are not limited to, Haematopinus asini, Haematopinus suis, Linognathus setosus, Linognathus ovillus, Pediculus humanus capitis, Pediculus humanus humanus, and Pthirus pubis.

In yet another embodiment, the pesticidal composition may be used to control pests in the Order Coleoptera. Non-limiting examples of genera may include, but are not limited to, Acanthoscelides spp., Agriotes spp., Anthonomus spp., Apion spp., Apogonia spp., Aulacophora spp., Bruchus spp., Cerosterna spp., Cerotoma spp., Ceutorhynchus spp., Chaetocnema spp., Colaspis spp., Ctenicera spp., Curculio spp., Cyclocephala spp., Diabrotica spp., Hypera spp., Ips spp., Lyctus spp., Megascelis spp., Meligethes spp., Otiorhynchus spp., Pantomorus spp., Phyllophaga spp., Phyllotreta spp., Rhizotrogus spp., Rhynchites spp., Rhynchophorus spp., Scolytus spp., Sphenophorus spp., Sitophilus spp., and Tribolium spp. Non-limiting examples of species may include, but are not limited to, Acanthoscelides obtectus, Agrilus planipennis, Anoplophora glabripennis, Anthonomus grandis, Ataenius spretulus, Atomaria linearis, Bothynoderes punctiventris, Bruchus pisorum, Callosobruchus maculatus, Carpophilus hemipterus, Cassida vittata, Cerotoma trifurcata, Ceutorhynchus assimilis, Ceutorhynchus napi, Conoderus scalaris, Conoderus stigmosus, Conotrachelus nenuphar, Cotinis nitida, Crioceris asparagi, Cryptolestes ferrugineus, Cryptolestes pusillus, Cryptolestes turcicus, Cylindrocopturus adspersus, Deporaus marginatus, Dermestes lardarius, Dermestes maculatus, Epilachna varivestis, Faustinus cubae, Hylobius pales, Hypera postica, Hypothenemus hampei, Lasioderma serricorne, Leptinotarsa decemlineata, Liogenys fuscus, Liogenys suturalis, Lissorhoptrus oryzophilus, Maecolaspis joliveti, Melanotus communis, Meligethes aeneus, Melolontha melolontha, Oberea brevis, Oberea linearis, Oryctes rhinoceros, Oryzaephilus mercator, Oryzaephilus surinamensis, Oulema melanopus, Oulema oryzae, Phyllophaga cuyabana, Popillia japonica, Prostephanus truncatus, Rhyzopertha dominica, Sitona lineatus, Sitophilus granarius, Sitophilus oryzae, Sitophilus zeamais, Stegobium paniceum, Tribolium castaneum, Tribolium confusum, Trogoderma variabile, and Zabrus tenebrioides.

In an alternative embodiment, the pesticidal composition may be used to control pests of the Order Dermaptera.

In another embodiment, the pesticidal composition may be used to control pests of the Order Blattaria. Non-limiting examples of species may include, but are not limited to, Blattella germanica, Blatta orientalis, Parcoblatta pennsylvanica, Periplaneta americana, Periplaneta australasiae, Periplaneta brunnea, Periplaneta fuliginosa, Pycnoscelus surinamensis, and Supella longipalpa.

In yet another embodiment, the pesticidal composition may be used to control pests of the Order Diptera. Non-limiting examples of genera may include, but are not limited to, Aedes spp., Agromyza spp., Anastrepha spp., Anopheles spp., Bactrocera spp., Ceratitis spp., Chrysops spp., Cochliomyia spp., Contarinia spp., Culex spp., Dasineura spp., Delia spp., Drosophila spp., Fannia spp., Hylemyia spp., Liriomyza spp., Musca spp., Phorbia spp., Tabanus spp., and Tipula spp. Non-limiting examples of species may include, but are not limited to, Agromyza frontella, Anastrepha suspensa, Anastrepha ludens, Anastrepha obliqa, Bactrocera cucurbitae, Bactrocera dorsalis, Bactrocera invadens, Bactrocera zonata, Ceratitis capitata, Dasineura brassicae, Delia platura, Fannia canicularis, Fannia scalaris, Gasterophilus intestinalis, Gracillia perseae, Haematobia irritans, Hypoderma lineatum, Liriomyza brassicae, Melophagus ovinus, Musca autumnalis, Musca domestica, Oestrus ovis, Oscinella frit, Pegomya betae, Psila rosae, Rhagoletis cerasi, Rhagoletis pomonella, Rhagoletis mendax, Sitodiplosis mosellana, and Stomoxys calcitrans.

In a particular embodiment, the pesticidal composition may be used to control pests of the Order Hemiptera. Non-limiting examples of genera may include, but are not limited to, Adelges spp., Aulacaspis spp., Aphrophora spp., Aphis spp., Bemisia spp., Ceroplastes spp., Chionaspis spp., Chrysomphalus spp., Coccus spp., Empoasca spp., Lepidosaphes spp., Lagynotomus spp., Lygus spp., Macrosiphum spp., Nephotettix spp., Nezara spp., Philaenus spp., Phytocoris spp., Piezodorus spp., Planococcus spp., Pseudococcus spp., Rhopalosiphum spp., Saissetia spp., Therioaphis spp., Toumeyella spp., Toxoptera spp., Trialeurodes spp., Triatoma spp. and Unaspis spp. Non-limiting examples of species may include, but are not limited to, Acrosternum hilare, Acyrthosiphon pisum, Aleyrodes proletella, Aleurodicus dispersus, Aleurothrixus floccosus, Amrasca biguttula biguttula, Aonidiella aurantii, Aphis gossypii, Aphis glycines, Aphis pomi, Aulacorthum solani, Bemisia argentifolii, Bemisia tabaci, Blissus leucopterus, Brachycorynella asparagi, Brevennia rehi, Brevicoryne brassicae, Calocoris norvegicus, Ceroplastes rubens, Cimex hemipterus, Cimex lectularius, Dagbertus fasciatus, Dichelops furcatus, Diuraphis noxia, Diaphorina citri, Dysaphis plantaginea, Dysdercus suturellus, Edessa meditabunda, Eriosoma lanigerum, Eurygaster maura, Euschistus heros, Euschistus servus, Helopeltis antonii, Helopeltis theivora, Icerya purchasi, Idioscopus nitidulus, Laodelphax striatellus, Leptocorisa oratorius, Leptocorisa varicornis, Lygus hesperus, Maconellicoccus hirsutus, Macrosiphum euphorbiae, Macrosiphum granarium, Macrosiphum rosae, Macrosteles quadrilineatus, Mahanarva frimbiolata, Metopolophium dirhodum, Mictis longicornis, Myzus persicae, Nephotettix cinctipes, Neurocolpus longirostris, Nezara viridula, Nilaparvata lugens, Parlatoria pergandii, Parlatoria ziziphi, Peregrinus maidis, Phylloxera vitifoliae, Physokermes piceae, Phytocoris californicus, Phytocoris relativus, Piezodorus guildinii, Poecilocapsus lineatus, Psallus vaccinicola, Pseudacysta perseae, Pseudococcus brevipes, Quadraspidiotus perniciosus, Rhopalosiphum maidis, Rhopalosiphum padi, Saissetia oleae, Scaptocoris castanea, Schizaphis graminum, Sitobion avenae, Sogatella furcifera, Trialeurodes vaporariorum, Trialeurodes abutiloneus, Unaspis yanonensis, and Zulia entrerriana.

In another embodiment, the pesticidal composition may be used to control pests of the Order Hymenoptera. Non-limiting examples of genera may include, but are not limited to, Acromyrmex spp., Atta spp., Camponotus spp., Diprion spp., Formica spp., Monomorium spp., Neodiprion spp., Pogonomyrmex spp., Polistes spp., Solenopsis spp., Vespula spp., and Xylocopa spp. Non-limiting examples of species may include, but are not limited to, Athalia rosae, Atta texana, Iridomyrmex humilis, Monomorium minimum, Monomorium pharaonis, Solenopsis invicta, Solenopsis geminata, Solenopsis molesta, Solenopsis richtery, Solenopsis xyloni, and Tapinoma sessile.

In an alternative embodiment, the pesticidal composition may be used to control pests of the Order Isoptera. Non-limiting examples of genera may include, but are not limited to, Coptotermes spp., Cornitermes spp., Cryptotermes spp., Heterotermes spp., Kalotermes spp., Incisitermes spp., Macrotermes spp., Marginitermes spp., Microcerotermes spp., Procornitermes spp., Reticulitermes spp., Schedorhinotermes spp., and Zootermopsis spp. Non-limiting examples of species may include, but are not limited to, Coptotermes curvignathus, Coptotermes frenchi, Coptotermes formosanus, Heterotermes aureus, Microtermes obesi, Reticulitermes banyulensis, Reticulitermes grassei, Reticulitermes flavipes, Reticulitermes hageni, Reticulitermes hesperus, Reticulitermes santonensis, Reticulitermes speratus, Reticulitermes tibialis, and Reticulitermes virginicus.

In another embodiment, the pesticidal composition may be used to control pests of the Order Lepidoptera. Non-limiting examples of genera may include, but are not limited to, Adoxophyes spp., Agrotis spp., Argyrotaenia spp., Cacoecia spp., Caloptilia spp., Chilo spp., Chrysodeixis spp., Colias spp., Crambus spp., Diaphania spp., Diatraea spp., Earias spp., Ephestia spp., Epimecis spp., Feltia spp., Gortyna spp., Helicoverpa spp., Heliothis spp., Indarbela spp., Lithocolletis spp., Loxagrotis spp., Malacosoma spp., Peridroma spp., Phyllonorycter spp., Pseudaletia spp., Sesamia spp., Spodoptera spp., Synanthedon spp., and Yponomeuta spp. Non-limiting examples of species may include, but are not limited to, Achaea janata, Adoxophyes orana, Agrotis ipsilon, Alabama argillacea, Amorbia cuneana, Amyelois transitella, Anacamptodes defectaria, Anarsia lineatella, Anomis sabulifera, Anticarsia gemmatalis, Archips argyrospila, Archips rosana, Argyrotaenia citrana, Autographa gamma, Bonagota cranaodes, Borbo cinnara, Bucculatrix thurberiella, Capua reticulana, Carposina niponensis, Chlumetia transversa, Choristoneura rosaceana, Cnaphalocrocis medinalis, Conopomorpha cramerella, Cossus cossus, Cydia caryana, Cydia funebrana, Cydia molesta, Cydia nigricana, Cydia pomonella, Darna diducta, Diatraea saccharalis, Diatraea grandiosella, Earias insulana, Earias vittella, Ecdytolopha aurantianum, Elasmopalpus lignosellus, Ephestia cautella, Ephestia elutella, Ephestia kuehniella, Epinotia aporema, Epiphyas postvittana, Erionota thrax, Eupoecilia ambiguella, Euxoa auxiliaris, Grapholita molesta, Hedylepta indicata, Helicoverpa armigera, Helicoverpa zea, Heliothis virescens, Hellula undalis, Keiferia lycopersicella, Leucinodes orbonalis, Leucoptera coffeella, Leucoptera malifoliella, Lobesia botrana, Loxagrotis albicosta, Lymantria dispar, Lyonetia clerkella, Mahasena corbetti, Mamestra brassicae, Maruca testulalis, Metisa plana, Mythimna unipuncta, Neoleucinodes elegantalis, Nymphula depunctalis, Operophtera brumata, Ostrinia nubilalis, Oxydia vesulia, Pandemis cerasana, Pandemis heparana, Papilio demodocus, Pectinophora gossypiella, Peridroma saucia, Perileucoptera coffeella, Phthorimaea operculella, Phyllocnistis citrella, Pieris rapae, Plathypena scabra, Plodia interpunctella, Plutella xylostella, Polychrosis viteana, Prays endocarpa, Prays oleae, Pseudaletia unipuncta, Pseudoplusia includens, Rachiplusia nu, Scirpophaga incertulas, Sesamia inferens, Sesamia nonagrioides, Setora nitens, Sitotroga cerealella, Sparganothis pilleriana, Spodoptera exigua, Spodoptera frugiperda, Spodoptera eridania, Thecla basilides, Tineola bisselliella, Trichoplusia ni, Tuta absoluta, Zeuzera coffeae, and Zeuzera pyrina.

In a particular embodiment, the pesticidal composition may be used to control pests of the Order Mallophaga. Non-limiting examples of genera may include, but are not limited to, Anaticola spp., Bovicola spp., Chelopistes spp., Goniodes spp., Menacanthus spp., and Trichodectes spp. Non-limiting examples of species may include, but are not limited to, Bovicola bovis, Bovicola caprae, Bovicola ovis, Chelopistes meleagridis, Goniodes dissimilis, Goniodes gigas, Menacanthus stramineus, Menopon gallinae, and Trichodectes canis.

In another embodiment, the pesticidal composition may be used to control pests of the Order Orthoptera. Non-limiting examples of genera may include, but are not limited to, Melanoplus spp., and Pterophylla spp. Non-limiting examples of species may include, but are not limited to, Anabrus simplex, Gryllotalpa africana, Gryllotalpa australis, Gryllotalpa brachyptera, Gryllotalpa hexadactyla, Locusta migratoria, Microcentrum retinerve, Schistocerca gregaria, and Scudderia furcata.

In yet another embodiment, the pesticidal composition may be used to control pests of the Order Siphonaptera. Non-limiting examples of species may include, but are not limited to, Ceratophyllus gallinae, Ceratophyllus niger, Ctenocephalides canis, Ctenocephalides felis, and Pulex irritans.

In an alternative embodiment, the pesticidal composition may be used to control pests of the Order Thysanoptera. Non-limiting examples of genera may include, but are not limited to, Caliothrips spp., Frankliniella spp., Scirtothrips spp., and Thrips spp. Non-limiting examples of species may include, but are not limited to, Frankliniella fusca, Frankliniella occidentalis, Frankliniella schultzei, Frankliniella williamsi, Heliothnps haemorrhoidalis, Rhipiphorothnps cruentatus, Scirtothrips citri, Scirtothrips dorsalis, and Taeniothrips rhopalantennalis, Thrips hawaiiensis, Thrips nigropilosus, Thrips orientalis, Thrips tabaci.

In another embodiment, the pesticidal composition may be used to control pests of the Order Thysanura. Non-limiting examples of genera may include, but are not limited to, Lepisma spp. and Thermobia spp.

In yet another embodiment, the pesticidal composition may be used to control pests of the Order Acarina. Non-limiting examples of genera may include, but are not limited to, Acarus spp., Aculops spp., Boophilus spp., Demodex spp., Dermacentor spp., Epitrimerus spp., Eriophyes spp., Ixodes spp., Oligonychus spp., Panonychus spp., Rhizoglyphus spp., and Tetranychus spp. Non-limiting examples of species may include, but are not limited to, Acarapis woodi, Acarus siro, Aceria mangiferae, Aculops lycopersici, Aculus pelekassi, Aculus schlechtendali, Amblyomma americanum, Brevipalpus obovatus, Brevipalpus phoenicis, Dermacentor variabilis, Dermatophagoides pteronyssinus, Eotetranychus carpini, Notoedres cati, Oligonychus coffeae, Oligonychus ilicis, Panonychus citri, Panonychus ulmi, Phyllocoptruta oleivora, Polyphagotarsonemus latus, Rhipicephalus sanguineus, Sarcoptes scabiei, Tegolophus perseaflorae, Tetranychus urticae, and Varroa destructor.

In a particular embodiment, the pesticidal composition may be used to control pest of the Order Symphyla. Non-limiting examples of species may include, but are not limited to, Scutigerella immaculata.

In another embodiment, the pesticidal composition may be used to control pests of the Phylum Nematoda. Non-limiting examples of genera may include, but are not limited to, Aphelenchoides spp., Belonolaimus spp., Criconemella spp., Ditylenchus spp., Heterodera spp., Hirschmanniella spp., Hoplolaimus spp., Meloidogyne spp., Pratylenchus spp., and Radopholus spp. Non-limiting examples of species may include, but are not limited to, Dirofilaria immitis, Heterodera zeae, Meloidogyne incognita, Meloidogyne javanica, Onchocerca volvulus, Radopholus similis, and Rotylenchulus reniformis.

The pesticidal composition may improve the stability of AIGA compound in soil and enhance the residue activities of AIGA compound in soil, while maintaining (if not enhancing) the pesticidal efficacy of AIGA compound. Enhancing the soil residues of AIGA compound in soil may depend on at least two factors: the types of nonionic surfactants, and the weight ratio of AIGA compound to nonionic surfactant.

Accordingly, in one particular embodiment, a method of controlling pests comprises applying a pesticidal composition to soil, wherein the pesticidal composition comprises at least one nonionic surfactant and an AIGA compound. The weight ratio of nonionic surfactant to AIGA compound is at least about 20:1, particularly at least about 25:1.

It is understood that the weight ratio of nonionic surfactant to AIGA compound in the pesticidal composition may be varied depending on various factors, such as application need, use rate, desired level of pesticidal efficacies, mode of application, type of pests to be controlled, etc.

The pesticidal compositions of EXAMPLES 1-5, infra, were prepared by mixing at least one nonionic surfactant with a sulfoxaflor concentrate (240 g/L or 500 g/kg). It is understood that the sulfoxaflor concentrate itself may contain a small amount of nonionic surfactant; therefore, the nonionic surfactant added to the sulfoxaflor concentrate may be considered as the “additional” nonionic surfactant. It is further understood that although the pesticidal compositions of EXAMPLES 1-5 use sulfoxaflor as the AIGA compound, other AIGA compounds may be used instead of sulfoxaflor, or may be used in combination with sulfoxaflor.

As shown in EXAMPLES 1-5, the pesticidal compositions (prepared by mixing an “additional” nonionic surfactant with a sulfoxaflor concentrate) show enhanced sulfoxaflor stability in soil, compared to a composition that contains sulfoxaflor concentrate without the additional nonionic surfactant. After an application to soil, the percentage of sulfoxaflor recovery of the pesticidal compositions in soil is much higher than that of a composition without the additional nonionic surfactant. Thus, the pesticidal compositions provide improved residue bioactivities in soil, compared to the similar composition that lacks the additional nonionic surfactant.

It is surprising and unexpected that a significantly enhanced sulfoxaflor stability in soil may be achieved by the pesticidal compositions. As shown in EXAMPLE 5, the pesticidal compositions may be effective and available for root uptake by the plant for a period of at least two weeks (14 days) after their application to soil, with the amount of pesticide equivalent to about 25% of that at the time immediately after application.

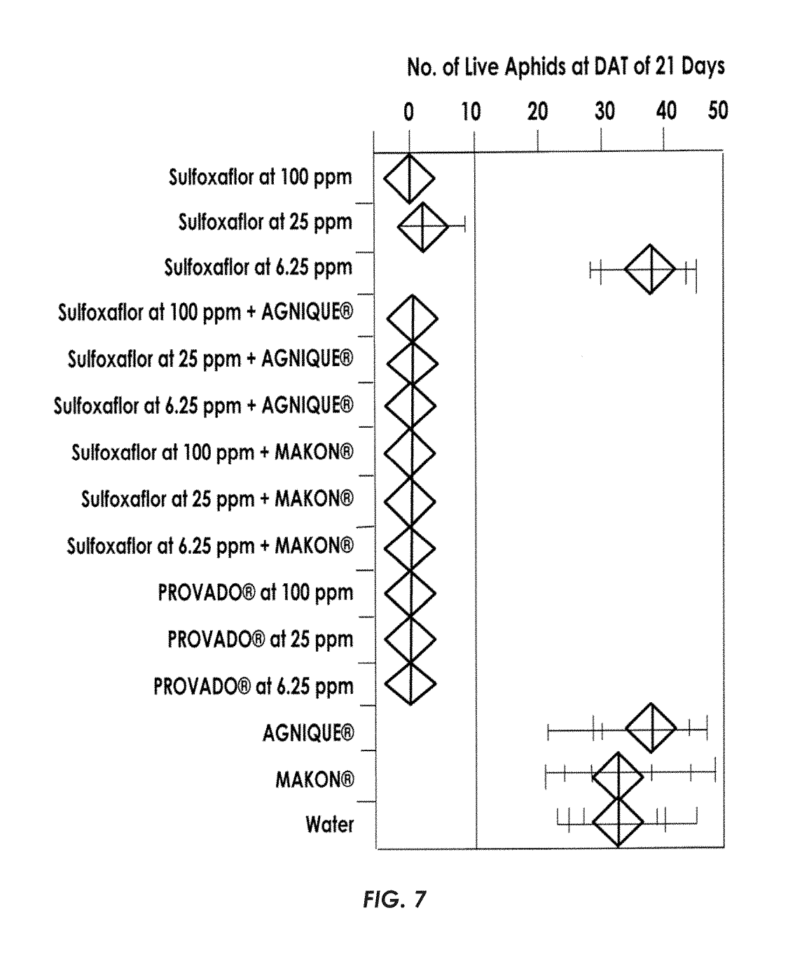

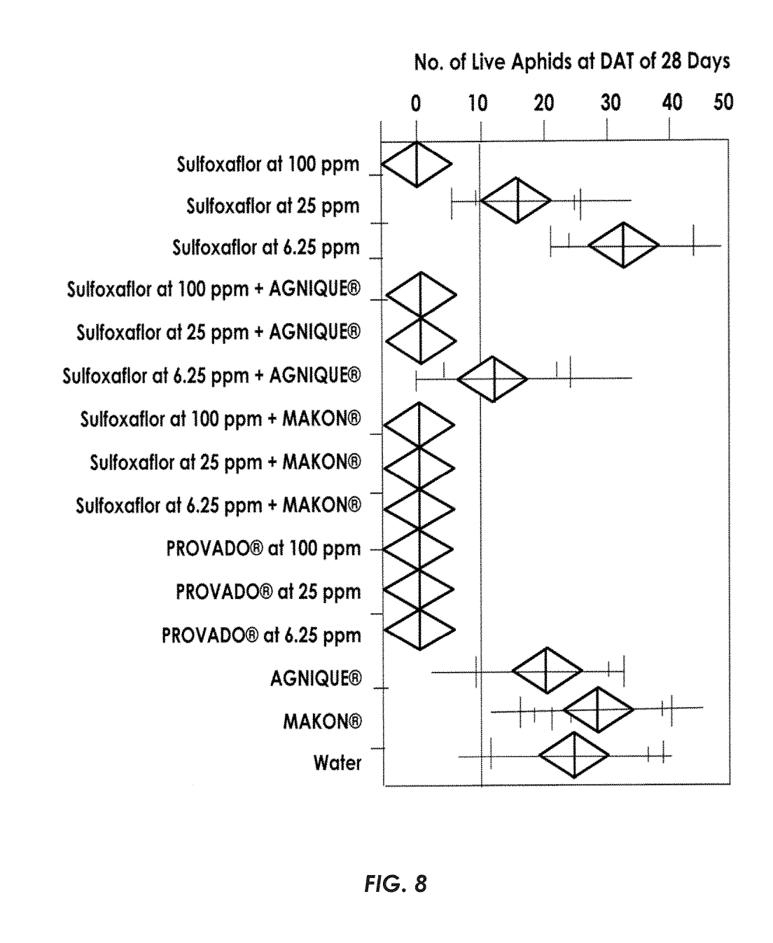

The present disclosure also envisages a method of controlling sap-feeding insects on the top part of plants by applying the pesticidal composition to the soil around the root system of the plant. EXAMPLE 7 shows the pesticidal activities against green peach aphid (Myzus persicae) when the soil around the root system of the plant is treated with the pesticidal compositions. As shown in FIGS. 7 and 8, the pesticidal compositions (prepared by mixing an “additional” nonionic surfactant with a sulfoxaflor concentrate) provide comparable pesticidal activities against green peach aphid (Myzus persicae) as a commercial imidacloprid pesticide (PROVADO® 1.6 pesticide from Bayer Crop Science LP).

Furthermore, TABLES 8-12 of EXAMPLE 7 shows that the pesticidal compositions may provide a synergistic pesticidal effect between sulfoxaflor and the additional nonionic surfactant against green peach aphid (Myzus persicae) on the top part of plants, when the pesticidal compositions are applied to the soil around the root system of the plants.

The following examples serve to explain embodiments of the present disclosure in more detail. These examples are not to be construed as being exhaustive or exclusive as to the scope of this disclosure.

### EXAMPLES

### Example 1. Effects of Nonionic Surfactants on Sulfoxaflor Stability in Inoculated Midwest Soil

Inoculated Midwest field soil was used for the study, and the soil moisture therein was measured by Mettler LJ16 Moisture Analyzer (15 minutes and 100° C.). For a consistent test protocol, the soil was dried at room temperature to about 8% initial soil moisture level. Then, the dry soil mass was calculated based on soil moisture. For Midwest soil, moisture between 26 and 30% is normally recommended. Therefore, 26% (i.e., 260,000 ppm) soil moisture was used for the tests.

Sulfoxaflor concentrates used in the study were CLOSER® SC insecticide from Dow AgroSciences, which has a sulfoxaflor concentration of 240 g/L (about 20% active sulfoxaflor); and TRANSFORM® WG insecticide also from Dow AgroSciences, which is a sulfoxaflor water dispersible granule formulation (WDG) having a sulfoxaflor concentration of 500 g/kg. A 500 ppm sulfoxaflor active solution was prepared by diluting the CLOSER® SC insecticide (240 g/L sulfoxaflor SC) or the TRANSFORM® WG insecticide (500 g/kg sulfoxaflor WDG) with deionized water.

Sulfoxaflor dose of about 6.25 ppm of sulfoxaflor active per gram of the final soil mixture (8.44 ppm of sulfoxaflor active per gram of dry soil mass) was used as standard application rate for EXAMPLE 1.

Surfactant dose of about 384 ppm surfactant per gram of final soil mixture was tested (384 μg surfactant per gram of final soil mixture; 1500 ppm of surfactant per gram of total soil liquid; 526 μg of surfactants per gram of dry soil mass).

A pesticidal composition was the composition that included the sulfoxaflor concentrate (CLOSER® SC insecticide or TRANSFORM® WG insecticide) but not additional surfactants.

A control soil sample was the soil sample treated with the control composition. The control soil sample was run with each test for comparison and was recorded as “No Surfactant” sample.

All tests were measured under the following conditions:

About 15 grams of inoculated Midwest field soil was measured by Mettler AE20 Analytical Balance and added into a 30 milliliter (mL) Nalgene Wide-Mouth HDPE plastic bottle. The sulfoxaflor active solution, various surfactant solutions (as shown in TABLE 1), and additional water were added into the plastic bottle to achieve 6.25 ppm of sulfoxaflor active, 384 ppm of surfactant, and 260,000 ppm water per gram of final soil mixture.

TABLE 1
Various nonionic surfactants used in the study

| Nonionic Surfactant | Description |
|---|---|
| AGNIQUE ® FOH TDA-9 | PEG-9 Tridecyl alcohol ether, from Cognis Corporation |
| ATPLUS ® S-10 | Polyoxyethylene alcohol and urea blend, from Uniqema |
| ATLAS ® G-5000 | Polyalkylene oxide polymers, from Uniqema |
| AGNIQUE ® PG 8105 | C8-C10 Alkyl polyglycoside with degree of polymer of |
| | 1.5, from Cognis Corporation |
| AGNIQUE ® PG 8107 | C8-C10 Alkyl polyglycoside with degree of polymer of |
| | 1.7, from Cognis Corporation |
| AGNIQUE ® PG 8116 | C8-C11 Alkyl polyglycoside with degree of polymer of |
| | 1.6, from Cognis Corporation |
| AGNIQUE ® PG 9116 | C9-C11 Alkyl polyglycoside with degree of polymer of |
| | 1.6, from Cognis Corporation |
| MAKON ® TD3 | PEG-3 tridecyl alcohol ether, from Stepan Company |
| AGNIQUE ® PG 266 | C12-C16 Alkyl polyglycoside with degree of polymer of |
| | 1.6, from Cognis Corporation |
| AGNIQUE ® PG 264 | C12-C16 Alkyl polyglycoside with degree of polymer of |
| | 1.4, from Cognis Corporation |
| ATLOX ® 4913 | Polymethyl methacrylate-polyethylene glycol graft |
| | copolymer, from Uniqema |
| ETHYLAN ® NS 500 LQ | Polyalkoxylated butyl ether, from Akzo Noble N.V. |
| PLURONIC ® P105 | EO-PO-EO block copolymer, from BASF Corporation |
| SILWET ™ 618 | Trisiloxane alkoxylate, from Momentive Performance |
| | Materials Inc. |
| TWEEN ® 21 | Polyethylene glycol (4) sorbitan ester of lauric acid (aka |
| | Polysorbate 21), from Uniqema |
| TWEEN ® 20 | Polyethylene glycol (20) sorbitan ester of lauric acid (aka |
| | Polysorbate 20), from Uniqema |

Each of the tested soil samples (including the control soil sample) was left under the same conditions for three days. After three days, the % sulfoxaflor recovery in the tested soils was determined using the following extraction procedure:

Sulfoxaflor was extracted from soil by adding 10 mL of acetonitrile with 0.01% formic acid. Two 12 mm glass beads were placed into the plastic bottle which was then shaken by hand until it was roughly homogeneous. The bottle was then shaken on high speed with a horizontal shaker for one hour (Eberbach Reciprocating Shaker 6010). About 10 mL of the extract was centrifuged for 7 minutes at 3000 rpm (Beckman J2-MI). The supernant was filtered with a 0.2 micron filter (Pall PTFE). About 750 microliters (μL) of the filtered extract and 25 μL of 4-ethylphenol (0.323 mg/mL of methanol) was added to a 2 mL glass autosampler vial with a micropipette (Evol by SGE Analytical).

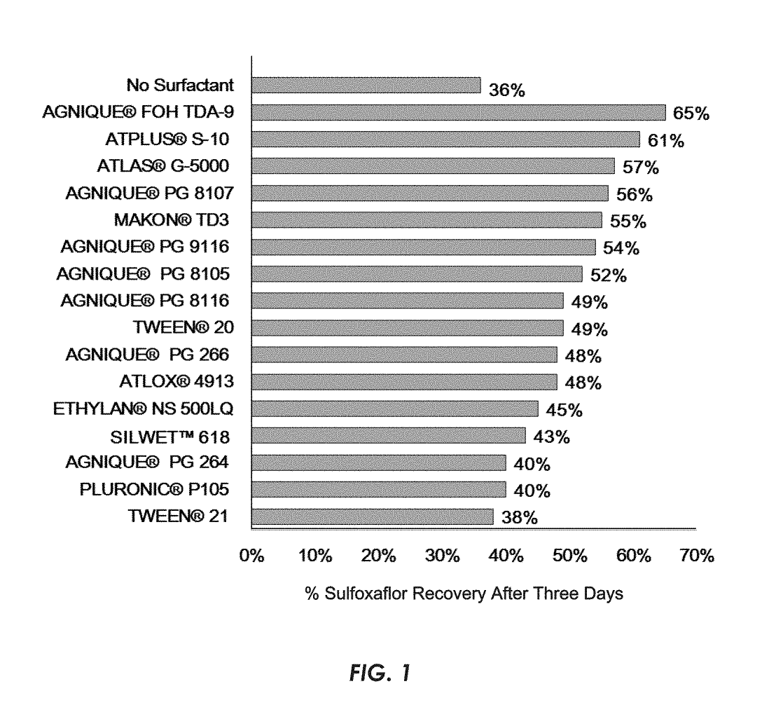

FIG. 1 shows the % sulfoxaflor recovery after three days for each of the soil samples treated with the pesticidal composition that includes about 6.25 ppm sulfoxaflor per final soil mixture and about 384 ppm of various surfactants (as shown in TABLE 1) per final soil mixture. For comparison, FIG. 1 also shows the % sulfoxaflor recovery for the control soil sample (the soil sample treated with the control composition; “No Surfactant” sample).

As shown in FIG. 1, about 36% of sulfoxaflor was recovered in the control soil sample (“No Surfactant” sample). The soil samples treated with the pesticidal compositions (containing both sulfoxaflor and nonionic surfactant) provided a higher % sulfoxaflor recovery, compared to the control “No Surfactant” sample. Furthermore, the enhancement in % sulfoxaflor recovery depended on the types the surfactants used in the pesticidal composition. For example, when the pesticidal composition included about 6.25 ppm of sulfoxaflor and about 384 ppm of ethoxylated alcohol AGNIQUE® FOH TDA-9 surfactant (a PEG-9 tridecyl alcohol ether surfactant), the % sulfoxaflor recovery after three days was about 65%, which was almost twice the % sulfoxaflor recovery in the control “No Surfactant” sample. When the pesticidal composition included about 6.25 ppm of sulfoxaflor and about 384 ppm of ethoxylated alcohol MAKON® TD3 surfactant (a PEG-3 tridecyl alcohol ether surfactant), the % sulfoxaflor recovery after three days was about 55%, which was almost 1.5 times higher than the % sulfoxaflor recovery in the control “No Surfactant” sample. When the pesticidal composition included about 6.25 ppm of sulfoxaflor and about 384 ppm of polyglycoside surfactant: C8-C10 alkyl polyglycoside with degree of polymer of 1.7 (AGNIQUE® PG 8107 surfactant), C9-C11 alkyl polyglycoside with degree of polymer of 1.6 (AGNIQUE® PG 9116 surfactant), or C8-C10 alkyl polyglycoside with degree of polymer of 1.5 (AGNIQUE® PG 8105 surfactant), the % sulfoxaflor recovery after three days were found at 56%, 54%, or 52%, respectively. When the pesticidal composition included about 6.25 ppm of sulfoxaflor and about 384 ppm of polysorbate TWEEN® 20 surfactant, the % sulfoxaflor recovery after three days was about 49%, which was about 1.36 times higher than that the 36% sulfoxaflor recovery for the control “No Surfactant” sample.

### Example 2. Effect of Different Concentrations of Alkyl Polyglycoside Surfactant on the Sulfoxaflor Stability in Inoculated Midwest Soil

Inoculated Midwest field soil was treated with the pesticidal compositions using the same protocol as described in EXAMPLE 1. Four pesticidal compositions were prepared, each containing about 6.25 ppm of sulfoxaflor per final soil mixture but with different amounts of alkyl polyglycoside AGNIQUE® PG 8107 surfactant (as shown in TABLE 2): 0 ppm (control “No Surfactant”), 128 ppm, 256 ppm, and 384 ppm per final soil mixture. The four pesticidal compositions were used for treatment of the inoculated Midwest soil, and the % sulfoxaflor recovery was determined after three days.

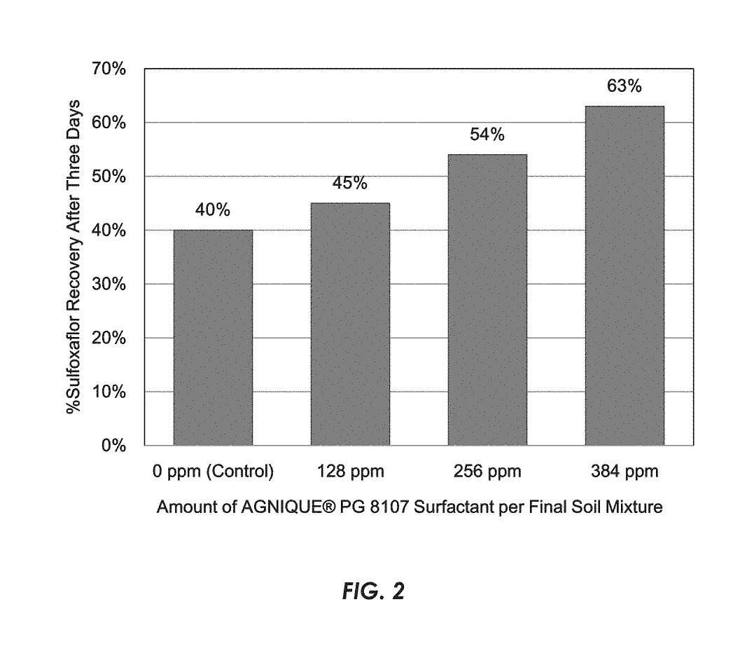

TABLE 2 and FIG. 2 show the % sulfoxaflor recovery after three days for each of the soil samples treated with the pesticidal compositions containing different amounts of alkyl polyglycoside AGNIQUE® PG 8107 surfactant.

TABLE 2
Comparative % sulfoxaflor recovery for the inoculated Midwest
soils treated with the pesticidal compositions containing different
amounts of alkyl polyglycoside AGNIQUE ® PG 8107 surfactant

| | Amount in Pesticidal Composition | | % |
|---|---|---|---|
| | (ppm per Final Soil Mixture) | | Sulfoxaflor |
| | | AGNIQUE ® | Recovery |
| | | PG 8107 | after |
| Tested Soil Sample | Sulfoxaflor | Surfactant | Three days |
| 0 ppm Sample | 6.25 ppm | 0 ppm | 40% |
| (Control) | | | |
| 128 ppm Sample | 6.25 ppm | 128 ppm | 45% |
| 256 ppm Sample | 6.25 ppm | 256 ppm | 54% |
| 384 ppm Sample | 6.25 ppm | 384 ppm | 63% |

As shown in TABLE 2 and FIG. 2, the % sulfoxaflor recovery after three days was enhanced when the pesticidal composition included alkyl polyglycoside AGNIQUE® PG 8107 surfactant. Furthermore, the higher % sulfoxaflor recovery was observed when the higher amounts of the alkyl polyglycoside AGNIQUE® PG 8107 surfactant was included in the pesticidal composition. For example, when the pesticidal composition included about 6.25 ppm of sulfoxaflor and about 384 ppm of alkyl polyglycoside AGNIQUE® PG 8107 surfactant, the % sulfoxaflor recovery after three days was about 63%, which was about 1.6 times higher than the 40% sulfoxaflor recovery in the control “No Surfactant” sample.

### Example 3. Effect of Different Concentrations of Ethoxylated Alcohol Surfactant on the Sulfoxaflor Stability in Inoculated Midwest Soil

Inoculated Midwest field soil was treated with the pesticidal composition using the same protocol as described in EXAMPLE 1. Four pesticidal compositions were prepared, each containing about 6.25 ppm of sulfoxaflor per final soil mixture but with different concentrations of ethoxylated alcohol AGNIQUE® FOH TDA-9 surfactant (as shown in TABLE 3): 0 ppm (control “No Surfactant”), 128 ppm, 256 ppm, and 384 ppm per final soil mixture. The four pesticidal compositions were used for treatment of the inoculated Midwest soil, and the % sulfoxaflor recovery was determined after three days.

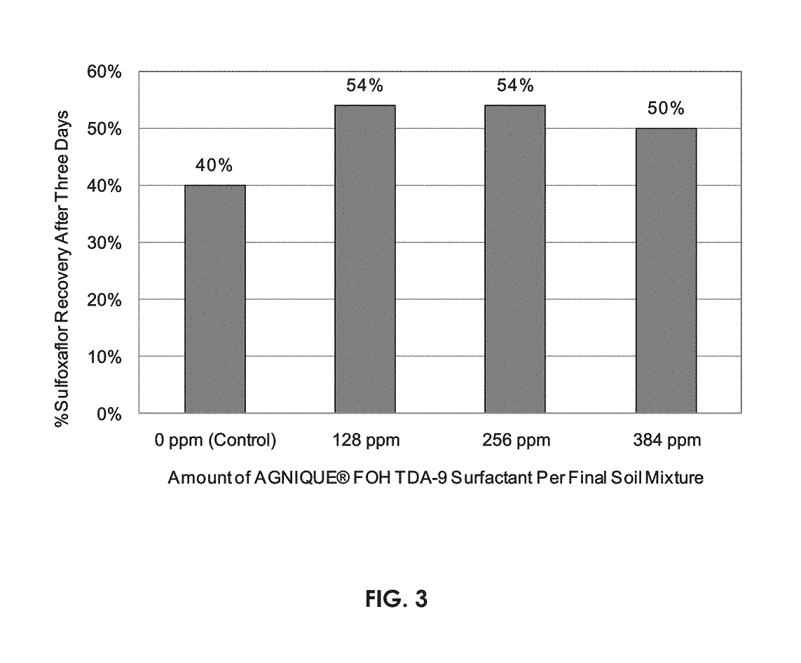

TABLE 3 and FIG. 3 show the % sulfoxaflor recovery after three days for each of the soil samples treated with the pesticidal compositions containing different amounts of ethoxylated alcohol AGNIQUE® FOH TDA-9 surfactant.

TABLE 3
Comparative % sulfoxaflor recovery for the soils treated
with the pesticidal compositions containing different amounts
of ethoxylated alcohol AGNIQUE ® FOH TDA-9 surfactant

| | Amount in Pesticidal Composition | | % |
|---|---|---|---|
| | (ppm per Final Soil Mixture) | | Sulfoxaflor |
| | | AGNIQUE ® | Recovery |
| | | FOH | after |
| Tested Soil Sample | Sulfoxaflor | TDA-9 Surfactant | Three days |
| 0 ppm Sample | 6.25 ppm | 0 ppm | 40% |
| (Control) | | | |
| 128 ppm Sample | 6.25 ppm | 128 ppm | 54% |
| 256 ppm Sample | 6.25 ppm | 256 ppm | 54% |
| 384 ppm Sample | 6.25 ppm | 384 ppm | 50% |

As shown in TABLE 3 and FIG. 3, the % sulfoxaflor recovery after three days was enhanced when ethoxylated alcohol AGNIQUE® FOH TDA-9 surfactant was included in the pesticidal compositions. However, the enhancement in the % sulfoxaflor recovery was appeared to be about the same (about 50% to 54%), regardless of the amount of the ethoxylated alcohol AGNIQUE® FOH TDA-9 surfactant in the pesticidal compositions.

### Example 4. Effect of Different Sulfoxaflor Concentrations (with or without Alkyl Polyglycoside Surfactant) on the Sulfoxaflor Stability in Inoculated Midwest Soil

Inoculated Midwest field soil was treated with the pesticidal composition using the same protocol as described in EXAMPLE 1. Six pesticidal compositions were prepared as shown in TABLE 4, and used for treatment of the inoculated Midwest soil. The % sulfoxaflor recovery was determined after three days.

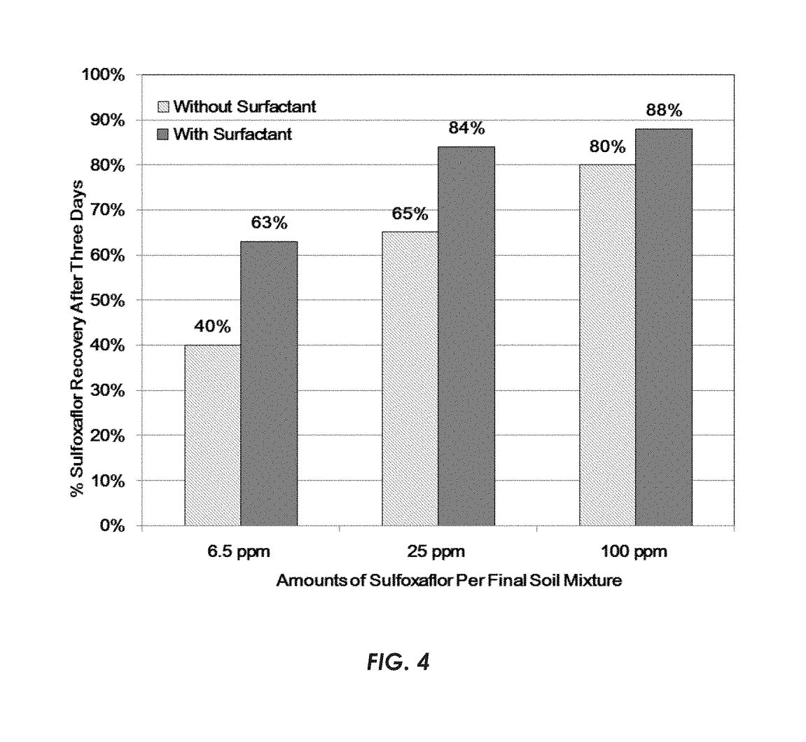

TABLE 4 and FIG. 4 show the % sulfoxaflor recovery after three days for each of the tested soil samples treated with the pesticidal compositions containing different amounts of sulfoxaflor and alkyl polyglycoside AGNIQUE® PG 8107 surfactant.

As expected, the soil samples treated with the pesticidal compositions having higher amounts of sulfoxaflor showed a higher % sulfoxaflor recovery after three days. The % sulfoxaflor recovery after three days was further enhanced when alkyl polyglycoside AGNIQUE® PG 8107 surfactant was included in the pesticidal compositions, regardless of the amount of sulfoxaflor in the pesticidal compositions.

TABLE 4
Comparative % sulfoxaflor recovery for the soils treated with
the pesticidal compositions containing different amounts of
sulfoxaflor and alkyl polyglycoside AGNIQUE ®
PG 8107 surfactant

| | Amount in Pesticidal Composition | | % |
|---|---|---|---|
| | (ppm per Final Soil Mixture) | | Sulfoxaflor |
| | | AGNIQUE ® | Recovery |
| | | PG 8107 | after |
| Tested Soil Sample | Sulfoxaflor | Surfactant | Three days |
| 6.25 ppm Sample | 6.25 ppm | 0 ppm | 40% |
| | 6.25 ppm | 384 ppm | 63% |
| 25 ppm Sample | 25 ppm | 0 ppm | 65% |
| | 25 ppm | 384 ppm | 84% |
| 100 ppm Sample | 100 ppm | V0 ppm | 80% |
| | 100 ppm | 384 ppm | 88% |

### Example 5. Effect of Different Nonionic Surfactants on Sulfoxaflor Stability in Inoculated Midwest Soil at Different Time Intervals

Inoculated Midwest field soil was treated with the pesticidal compositions using the same protocol as described in EXAMPLE 1. The pesticidal compositions included about 6.25 ppm sulfoxaflor and about 384 ppm nonionic surfactant per final soil mixture. The control sample (“No Surfactant” sample) was the soil sample treated with the control composition (i.e., the composition that contained about 6.5 ppm sulfoxaflor per final soil mixture and did not contain additional nonionic surfactant).

The % sulfoxaflor recovery was determined at different time intervals after treating the soil with the pesticidal compositions: 0 day (immediately after treating the soil with the pesticidal compositions); 3 days, 5 days, 7 days (one week after treating the soil with the pesticidal compositions), 10 days, 12 days, and 14 days (two weeks after treating the soil with the pesticidal compositions). Two types of nonionic surfactants were studied: alkyl polyglycoside AGNIQUE® PG 8107 surfactant, and alkyl ethoxylated PEG-3 tridecyl alcohol ether MAKON® TD3 surfactant.

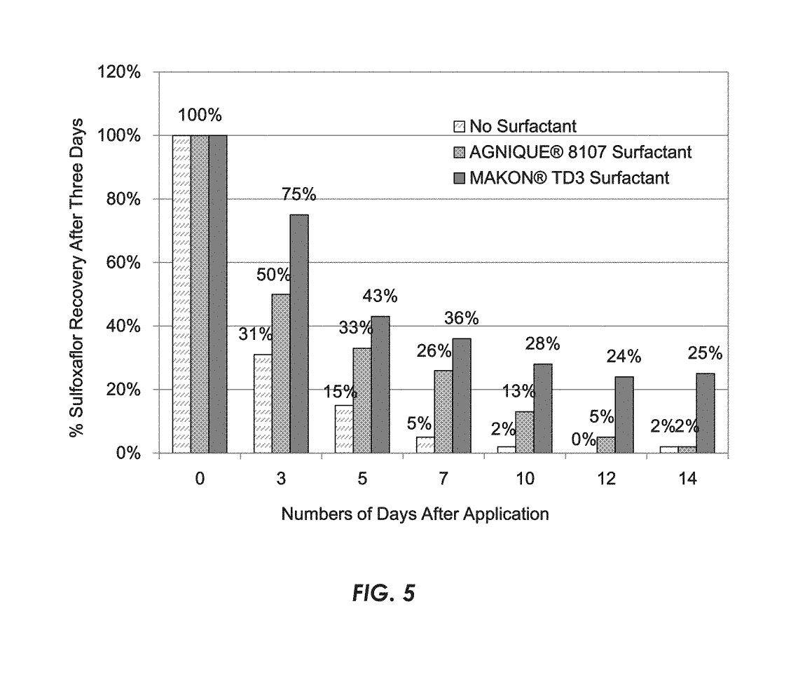

As shown in FIG. 5, the % sulfoxaflor recovery increased when the pesticidal compositions included nonionic surfactant in addition to sulfoxaflor. Furthermore, at the same time interval and the same weight ratio of nonionic surfactant to sulfoxaflor, the alkyl ethoxylated PEG-3 tridecyl alcohol ether MAKON® TD3 surfactant seemed to be superior for improving the % sulfoxaflor recovery, compared to the alkyl polyglycoside AGNIQUE® PG 8107 surfactant.

After one week (7 days) of applying the pesticidal compositions to the soil, the control soil sample (“No Surfactant” sample) showed only 5% sulfoxaflor recovery. About 36% sulfoxaflor recovery was observed for the soil sample treated with pesticidal compositions containing alkyl ethoxylated PEG-3 tridecyl alcohol ether MAKON® TD3 surfactant, and about 26% sulfoxaflor recovery for the soil sample treated with the pesticidal compositions containing alkyl polyglycoside AGNIQUE® PG 8107 surfactant. Thus, by including either alkyl ethoxylated PEG-3 tridecyl alcohol ether MAKON® TD3 surfactant or alkyl polyglycoside AGNIQUE® PG 8107 surfactant in the pesticidal compositions, the % sulfoxaflor recovery after one week could enhance up to seven (7) times compared to the control “No Surfactant” sample.

After two weeks (14 days) of applying the pesticidal compositions to the soil, only 2% sulfoxaflor recovery was detected in the control soil sample. About 25% sulfoxaflor recovery was found for the soil sample treated with the pesticidal composition containing alkyl ethoxylated PEG-3 tridecyl alcohol ether MAKON® TD3 surfactant, while about 2% sulfoxaflor recovery was observed for the soil sample treated with the pesticidal compositions containing alkyl polyglycoside AGNIQUE® PG 8107 surfactant. About 25% of the sulfoxaflor still left in the soil at two weeks after the application, while basically no sulfoxaflor left in the treated with the control composition. Thus, the alkyl ethoxylated PEG-3 tridecyl alcohol ether MAKON® TD3 surfactant significantly enhanced sulfoxaflor stability in soil.

### Example 6. Effect of Different Antifoaming Agents on the Sulfoxaflor Stability in Inoculated Midwest Soil

Inoculated Midwest field soil was treated with the pesticidal compositions using the same protocol as described in EXAMPLE 1. Five pesticidal compositions were prepared as shown in TABLE 5, and the % sulfoxaflor recovery was determined after three days. For the pesticidal compositions containing surfactant, the pesticidal compositions included about 6.25 ppm sulfoxaflor and about 384 ppm alkyl polyglycoside AGNIQUE® PG 8107 surfactant per final soil mixture.

TABLE 5
Comparative % sulfoxaflor recovery for the soils treated with the
pesticidal compositions containing sulfoxaflor with or without alkyl
polyglycoside AGNIQUE ® PG 8107 surfactant, and with
or without antifoaming agent

| | Amount in Pesticidal Composition | | | % |
|---|---|---|---|---|
| | (ppm per Final Soil Mixture) | | | Sulfoxaflor |
| | | AGNIQUE ® | | Recovery |
| | | PG 8107 | Antifoaming | after |
| Tested Soil Sample | Sulfoxaflor | Surfactant | Agent | Three days |
| No Surfactant, | 6.25 ppm | 0 ppm | None | 49% |
| No Antifoaming Agent | | | | |
| (Control Sample) | | | | |
| Surfactant, | 6.25 ppm | 384 ppm | None | 63% |
| No Antifoaming Agent | | | | |
| Surfactant (+) | 6.25 ppm | 384 ppm | DOW | 75% |
| DOW CORNING ® | | | CORNING ® | |
| Antifoaming Agent | | | Antifoam C | |
| | | | Emulsion | |
| Surfactant (+) | 6.25 ppm | 384 ppm | SILFOAM ® 203 | 61% |
| SILFOAM ® 203 | | | Antifoaming | |
| Antifoaming Agent | | | Agent | |
| Surfactant (+) | 6.25 ppm | 384 ppm | SILFOAM ® 200 | 65% |
| SILFOAM ® 200 | | | Antifoaming | |
| Antifoaming Agent | | | Agent | |

As shown in TABLE 5, three different types of antifoaming agents were used for the study: DOW CORNING® Medical Antifoam C Emulsion from Dow Corning Corporation, which is a food grade, water-dilutable silicone defoamer containing about 30% polydimethylsiloxane; SILFOAM® SC 203 antifoaming agent from Wacker Chemie AG, which is a food grade, 100% actives solvent dispersible silicone compound; and SILFOAM® SC 200 antifoaming agent from Wacker Chemie AG, which is a food grade, 13% active silicone defoamer emulsion. When the antifoaming agent was included in the pesticidal compositions, the amount of antifoaming agent was about 66 ppm based on the total soil liquid.

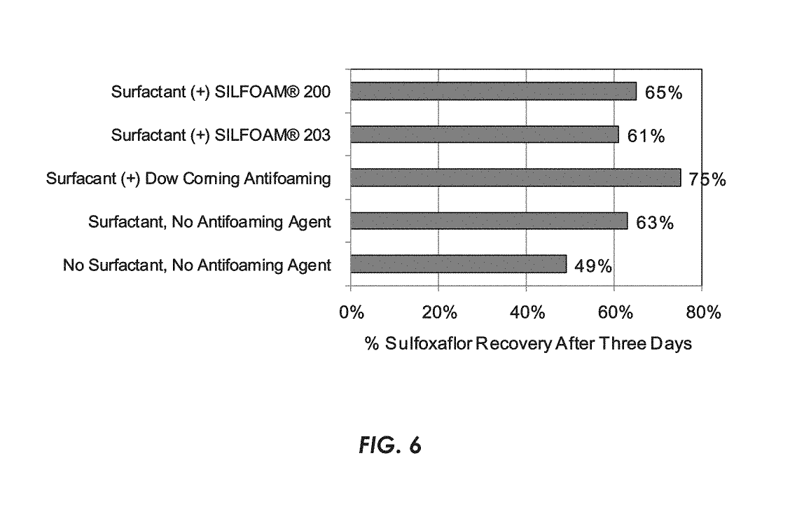

TABLE 5 and FIG. 6 show the % sulfoxaflor recovery after three days for each of the tested soil samples. The soils treated with the pesticidal compositions including about 6.25 ppm sulfoxaflor and about 384 ppm alkyl polyglycoside AGNIQUE® PG 8107 surfactant per final soil mixture, showed about 63% sulfoxaflor recovery after three days, which was higher than the 49% sulfoxaflor recovery for the control soil sample (i.e., the soil sample that was treated with the control composition having about 6.25 ppm sulfoxaflor but no AGNIQUE® PG 8107 surfactant). Thus, as discussed previously, the presence of alkyl polyglycoside AGNIQUE® PG 8107 surfactant in the pesticidal compositions enhanced sulfoxaflor stability in soil.

Furthermore, as shown in TABLE 5 and FIG. 6, the presence of the antifoaming agent in the pesticidal compositions along with the alkyl polyglycoside AGNIQUE® PG 8107 surfactant, did not appear to impact the % sulfoxaflor recovery (i.e., the stability of sulfoxaflor in soil).

### Example 7. Pesticidal Activities Against Green Peach Aphid (Myzus persicae)

Preparation of Tested Compositions

Each tested compositions was prepared by mixing a predetermined amount of the CLOSER® SC insecticide (a sulfoxaflor concentrate having a sulfoxaflor concentration of 240 g/L) with a predetermined amount of the selected nonionic surfactant in an aqueous medium. Two nonionic surfactants were used in the study: alkyl polyglycoside AGNIQUE® PG 8107 surfactant from Cognis Corporation (C8-C10 alkyl polyglycoside with degree of polymer of 1.7), and PEG-3 tridecyl alcohol ether MAKON® TD3 surfactant from Stepan Company.

TABLE 6
Amounts of sulfoxaflor and nonionic surfactant
in the tested compositions

| | Amount of the Component | |
|---|---|---|
| | (% weight based on | |
| | total composition weight) | |
| Tested Composition | | Non-ionic |
| (as labeled in FIG. 7) | Sulfoxaflor | Surfactant |
| Sulfoxaflor at 100 ppm | 0.043% | None |
| Sulfoxaflor at 25 ppm | 0.011% | None |
| Sulfoxaflor at 6.25 ppm | 0.003% | None |
| Sulfoxaflor at 100 ppm + AGNIQUE ® | 0.043% | 0.225% |
| Sulfoxaflor at 25 ppm + AGNIQUE ® | 0.011% | 0.225% |
| Sulfoxaflor at 6.25 ppm + AGNIQUE ® | 0.003% | 0.225% |
| Sulfoxaflor at 100 ppm + MAKON ® | 0.043% | 0.225% |
| Sulfoxaflor at 25 ppm + MAKON ® | 0.011% | 0.225% |
| Sulfoxaflor at 6.25 ppm + MAKON ® | 0.003% | 0.225% |

The compositions containing different amounts of sulfoxaflor and nonionic surfactant were prepared as shown in TABLE 6. For example, the “Sulfoxaflor at 100 ppm” composition contained about 0.043% weight of sulfoxaflor based on the total weight of the composition (i.e., 100 ppm of sulfoxaflor per one gram of final soil mixture). “Sulfoxaflor at 100 ppm+AGNIQUE®” composition contained about 0.043% weight of sulfoxaflor based on the total weight of the composition (i.e., 100 ppm of sulfoxaflor per one gram of final soil mixture), and about 0.225% weight of alkyl polyglycoside AGNIQUE® PG 8107 surfactant based on the total weight of the composition (i.e., 384 ppm per one gram of the final soil mixture; 1500 ppm per one gram of the total soil liquid).

The imidacloprid pesticide PROVADO® 1.6 from Bayer CropScience LP (North Carolina, USA) was used as a standard commercial pesticidal composition for aphid control. The imidacloprid pesticide PROVADO® 1.6 was tested at three different loadings: 100 ppm, 25 ppm, and 6.25 ppm per gram of final soil mixture.

In this EXAMPLE 7, water was tested as a control composition. Furthermore, an aqueous solution of alkyl polyglycoside AGNIQUE® PG 8107 surfactant and an aqueous solution of PEG-3 tridecyl alcohol ether MAKON® TD3 surfactant were tested.

Determination of Pesticidal Activities Against Green Peach Aphid

Cabbage plants (Brassica oleracea capitata L) of uniform size (two new leaf stage) infested with green peach aphids (Myzus persicae) (“GPA”) were used as the study models according to the following procedure:

Cabbage seeds were planted in 3-inch pots containing a peat-based METRO MIX 360® potting soil available from SUN GRO® Horticulture Canada, Ltd. The seeds were propagated in greenhouse zone G4, located in the R&D building of Dow AgroSciences (Indianapolis, Ind., USA), at 26° C. with a relative humidity of 53%. Natural light was supplemented with 1,000-watt metal halide overhead lamps with an average illumination of about 500 μE/m².s photosynthetic active radiation for 16 consecutive hours each day.

Each of the 1-ounce clear cups was filled with about 30 grams of the inoculated Midwest field soil having the components as shown in TABLE 7. The Midwest soil was a silt loam soil that was collected from the Fowler Field Station (Fowler, Ind.), and had a pH of about 6.9. The soil moisture of the Midwest field soil was about 15% as measured by Mettler LJ16 Moisture Analyzer (15 minutes and 100° C.).

TABLE 7
Components of the Midwest soil used for the study

| Component | Amount |
|---|---|
| Organic Matter | 3.9% by L.O.I. |
| Available Phosphorus | 22 ppm (M) |
| Potassium | 1.1%; 84 ppm (L) |
| Magnesium | 28.5%; 670 (VH) |
| Calcium | 68.9%; 2500 (H) |
| Hydrogen | 1.5% |
| Sands | 35% |
| Silt | 35% |
| Clay | 30% |

The Midwest field soil in each selected 1-ounce cup was treated with about 9 mL of the selected composition using a 10 mL pipette. Deionized water was used as a control. The remainders of the 1-once cups were capped, and a small hole was poked into each lid to provide air flow. The remainders of the 1-ounce cups were stored in a controlled environment at 26° C. and covered with a black plastic bag to prevent any light from entering, until being used for the test.

Cabbage plants were gently removed from the 3-inch pots, and the plant roots were washed with water to remove any excess soil. Then, the cabbage plant was transplanted into the 1-ounce cup containing the treated Midwest field soil (one cabbage plant per one 1-ounce cup). The plants were watered as needed after being transplanted.

At the selected number of days after treating the Midwest field soil with the composition (i.e., numbers of days after the soil treatment, “DAT”), the cabbage plant in each 1-ounce cup was infested with GPA by placing a piece of squash leaf infested with about 25 aphids on each cabbage plant. The plants were then placed in a controlled environment at 26° C. for three days.

Five different evaluation times were performed: DAT of 0, 7, 14, 21, or 28 days. For example, for the DAT of zero (0) day, the cabbage plant was infested with GPA on the same day that it was transplanted into the treated Midwest field soil. Likewise, for the DAT of 14 days, the cabbage plant was infested with GPA 14 days after it was transplanted to the treated Midwest field soil. Each DAT evaluation time was replicated five times.

The pesticidal activity against GPA was determined three days after infestation, by counting the number of live GPA aphids present on each cabbage plant.

FIG. 7 showed the pesticidal activity against GPA at DAT of 21 days. The cabbages in the Midwest soil treated with the “Sulfoxaflor at 100 ppm” composition showed no live GPA aphid at DAT of 21 days; whereas, the cabbages in the Midwest soil treated with the “Sulfoxaflor at 6.25 ppm” composition showed about 38 live GPA aphids at DAT of 21 days. Thus, at the DAT of 21 days, the soil treated with 100 ppm sulfoxaflor showed a nearly complete control of GPA, while the soil treated with only 6.25 ppm sulfoxaflor showed insufficient control of GPA.

When nonionic surfactant was included along with sulfoxaflor in the composition for the soil treatment, the cabbages in the treated soils showed no live GPA aphid at DAT of 21 days, regardless of the loading amount of sulfoxaflor in the composition (i.e., 100 ppm, 25 ppm, or 6.25 ppm) and the types of nonionic surfactant (i.e., alkyl polyglycoside AGNIQUE® PG 8107 surfactant or PEG-3 tridecyl alcohol ether MAKON® TD3 surfactant). Thus, by including a nonionic surfactant in the pesticidal composition along with sulfoxaflor for the soil treatment, the pesticidal activity against GPA was enhanced to almost 100% control at DAT of 21 days.

The cabbages in the soils treated with the commercial PROVADO® 1.6 pesticide showed no live GPA aphid at DAT of 21 days, regardless of the loading amounts (i.e., 100 ppm, 25 ppm, or 6.25 ppm). Thus, the disclosed compositions comprising sulfoxaflor and nonionic surfactant showed the same level of pesticidal activity against GPA as the commercial PROVADO® 1.6 pesticide (i.e., almost 100% control) at DAT of 21 days.

Furthermore, the cabbages in the soils treated with the compositions containing nonionic surfactant but not sulfoxaflor (i.e., the “AGNIQUE®” composition and the “MAKON®” composition in FIG. 7) and the cabbages in the soil treated with only water (i.e., the “Water” composition in FIG. 7) showed insufficient control of GPA at DAT of 21 days (about 30 to 40 live GPA were found at DAT of 21 days).

FIG. 8 showed the pesticidal activity against GPA at DAT of 28 days. The cabbages in the Midwest soil treated with the “Sulfoxaflor at 100 ppm” composition showed no live GPA aphid; whereas, the cabbages in the Midwest soils treated with lower amount of sulfoxaflor (i.e., “Sulfoxaflor at 25 ppm” and “Sulfoxaflor at 6.25 ppm”) did not show 100% control of GPA.

At DAT of 28 days, the soil treatment with the composition comprising sulfoxaflor and alkyl polyglycoside AGNIQUE® PG 8107 nonionic surfactant showed 100% GPA control at the sulfoxaflor loading of 100 ppm or 25 ppm. However, the soil treated with the composition comprising sulfoxaflor and alkyl polyglycoside AGNIQUE® PG 8107 nonionic surfactant at the sulfoxaflor loading of 6.25 ppm did not show 100% GPA control at DAT of 28 days.

When PEG-3 tridecyl alcohol ether MAKON® TD3 surfactant was used as the nonionic surfactant along with sulfoxaflor in the composition for the soil treatment, the cabbages in the treated soils showed no live GPA aphid at DAT of 28 days, regardless of the loading amount of sulfoxaflor in the composition (i.e., 100 ppm, 25 ppm, or 6.25 ppm). This level of pesticidal activity against GPA was about the same as that of commercial PROVADO® 1.6 pesticide, which also provided 100% GPA control at DAT of 28 days regardless of the amount of pesticidal loading.

Determination of Synergistic Effect of Sulfoxaflor and Nonionic Surfactant for the Soil Treatment Against Green Peach Aphid (Myzus persicae)

The method described in Colby S. R., Calculating Synergistic and Antagonistic Responses of Herbicide Combinations, Weeds, 1967, 15, 20-22 was used to determine an existence of synergistic effect between sulfoxaflor and nonionic surfactant in the composition for the soil treatment. In this method, the percent insect control of the composition as observed in the study was compared to the “expected” percent control (E) as calculated by equation (1) (hereinafter “Colby's equation”) below:

$$E = X + Y - ( \frac{XY}{100} ) \qquad ( 1 )$$

where

X is the percentage of control with sulfoxaflor at a given rate (p),

Y is the percentage of control with nonionic surfactant at a given rate (q), and

E is the expected control by the sulfoxaflor and the nonionic surfactant at a rate of p+q.

If the observed percent control of the composition is greater than E, there is a synergistic effect between sulfoxaflor and nonionic surfactant in the composition for the soil treatment. If the observed percent control of the composition is equaled to or less than E, there is no synergistic effect between sulfoxaflor and nonionic surfactant in the composition for the soil treatment.

TABLE 8
Pesticidal activities against green peach aphids (Myzus persicae)
at 21 days after the soil treatment using sulfoxaflor loading of
6.25 ppm, with or without alkyl polyglycoside AGNIQUE ®
PG 8107 surfactant

| | Dose Rate | % Control |
|---|---|---|
| Soil Treatment | (ppm) | at DAT of 21 days |
| Sulfoxaflor | 6.25 | 0 |
| AGNIQUE ® PG 8107 Surfactant | 384 | 0 |
| Sulfoxaflor + AGNIQUE ® | 6.25 + 384 | 100 |
| PG 8107 Surfactant | | |
| Colby's Expected Action | 6.25 + 384 | 0 |
| Differences: Observed vs. Expected | 6.25 + 384 | 100 |

TABLE 8 shows the percent control of GPA when the Midwest field soil was treated with different compositions at DAT of 21 days. When the composition comprising about 6.25 ppm of sulfoxaflor and about 384 ppm of AGNIQUE® PG 8107 nonionic surfactant (i.e., 1500 ppm per one gram of total soil liquid) was used for the soil treatment, the % control against GPA was determined as the “Observed” action, and compared to those obtained from the soil treatment using either 6.25 ppm of sulfoxaflor alone, or 384 ppm of AGNIQUE® PG 8107 nonionic surfactant alone. The “Colby's Expected Action” was calculated using Colby's equation as discussed previously.

As shown in TABLE 8, no control against GPA at DAT of 21 days was observed when the soils were treated with either sulfoxaflor (at 6.25 ppm) alone or AGNIQUE® PG 8107 nonionic surfactant alone. Thus, the expected percentage control according to Colby's equation was calculated to be zero (0). Surprisingly and unexpectedly, about 100% control against GPA was observed when the soil was treated with a composition comprising both sulfoxaflor and AGNIQUE® PG 8107 nonionic surfactant. Thus, sulfoxaflor and AGNIQUE® PG 8107 nonionic surfactant showed a synergistic effect against GPA when used together in the composition for the soil treatment.

TABLE 9
Pesticidal activities against green peach aphids (Myzus persicae)
at 28 days after the soil treatment using sulfoxaflor loading
of 25 ppm, with or without alkyl polyglycoside AGNIQUE ®
PG 8107 surfactant

| | Dose Rate | % Control |
|---|---|---|
| Soil Treatment | (ppm) | at DAT of 28 days |
| Sulfoxaflor | 25 | 36.39 |
| AGNIQUE ® PG 8107 Surfactant | 384 | 20 |
| Sulfoxaflor + AGNIQUE ® | 25 + 384 | 100 |
| PG 8107 Surfactant | | |
| Colby's Expected Action | 25 + 384 | 49.1 |
| Differences: Observed vs. Expected | 25 + 384 | 50.9 |

As shown in TABLE 9, about 100% control against GPA was observed at the evaluation time DAT of 28 days when the soil was treated with a composition comprising both sulfoxaflor and AGNIQUE® PG 8107 nonionic surfactant. This was about two times higher than the expected percentage control according to Colby's equation (49.1%). It was surprising and unexpected that not only there was a synergistic effect against GPA between sulfoxaflor and AGNIQUE® PG 8107 nonionic surfactant in the composition for the soil treatment, but also the large magnitude of such synergistic effect.

TABLE 10
Pesticidal activities against green peach aphids (Myzus persicae)
at 28 days after the soil treatment using sulfoxaflor loading of
6.25 ppm, with or without alkyl polyglycoside AGNIQUE ®
PG 8107 surfactant

| | Dose Rate | % Control |
|---|---|---|
| Soil Treatment | (ppm) | at DAT of 28 days |
| Sulfoxaflor | 6.25 | 0 |
| AGNIQUE ® PG 8107 Surfactant | 384 | 20 |
| Sulfoxaflor + AGNIQUE ® | 6.25 + 384 | 53.87 |
| PG 8107 Surfactant | | |
| Colby's Expected Action | 6.25 + 384 | 20 |
| Differences: Observed vs. Expected | 6.25 + 384 | 33.9 |

TABLE 10 showed that at DAT of 28 days, the observed percent control against GPA (53.87%) was almost three times higher than the expected percentage control according to Colby's equation (20%).

TABLE 11
Pesticidal activities against green peach aphids (Myzus persicae)
at 21 days after the soil treatment using sulfoxaflor loading of
6.25 ppm, with or without PEG-3 tridecyl alcohol ether MAKON ®
TD3 surfactant

| | Dose Rate | % Control |
|---|---|---|
| Soil Treatment | (ppm) | at DAT of 21 days |
| Sulfoxaflor | 6.25 | 0 |
| MAKON ® TD3 Surfactant | 384 | 20 |
| Sulfoxaflor + MAKON ® TD3 | 6.25 + 384 | 100 |
| Surfactant | | |
| Colby's Expected Action | 6.25 + 384 | 20 |
| Differences: Observed vs. Expected | 6.25 + 384 | 100 |

TABLE 11 showed that about 100% control against GPA was observed at DAT of 21 days when the soil was treated with a composition comprising both sulfoxaflor and MAKON® TD3 nonionic surfactant, while the expected percentage control according to Colby's equation was 20%. Thus, sulfoxaflor and MAKON® TD3 nonionic surfactant showed a synergistic effect against GPA when used together in the composition for the soil treatment.

TABLE 12
Pesticidal activities against green peach aphids (Myzus persicae)
at 28 days after the soil treatment using sulfoxaflor loading of
25 ppm, with or without PEG-3 tridecyl alcohol ether MAKON ®
TD3 surfactant

| | Dose Rate | % Control |
|---|---|---|
| Soil Treatment | (ppm) | at DAT of 28 days |
| Sulfoxaflor | 25 | 36.39 |
| MAKON ® TD3 Surfactant | 384 | 0 |
| Sulfoxaflor + MAKON ® TD3 | 25 + 384 | 100 |
| Surfactant | | |
| Colby's Expected Action | 25 + 384 | 36.4 |
| Differences: Observed vs. Expected | 25 + 384 | 63.6 |

TABLE 12 showed that at DAT of 28 days, the observed percent control against GPA was about 100%, which was about 2.75 times higher than the expected percentage control according to Colby's equation (36.4%).

TABLE 13
Pesticidal activities against green peach aphids (Myzus persicae)
at 28 days after the soil treatment using sulfoxaflor loading of
6.25 ppm, with or without PEG-3 tridecyl alcohol ether MAKON ®
TD3 surfactant

| | Dose Rate | % Control |
|---|---|---|
| Soil Treatment | (ppm) | at DAT of 28 days |
| Sulfoxaflor | 6.25 | 0 |
| MAKON ® TD3 Surfactant | 384 | 0 |
| Sulfoxaflor + MAKON ® TD3 | 6.25 + 384 | 100 |
| Surfactant | | |
| Colby's Expected Action | 6.25 + 384 | 0 |
| Differences: Observed vs. Expected | 6.25 + 384 | 100 |

TABLE 13 showed that about 100% control against GPA was observed at DAT of 28 days when the soil was treated with a composition comprising both sulfoxaflor and MAKON® TD3 nonionic surfactant, while the expected percentage control according to Colby's equation was 0%. Thus, sulfoxaflor and MAKON® TD3 nonionic surfactant showed a synergistic effect against GPA when used together in the composition for the soil treatment.

While the present disclosure may be susceptible to various modifications and alternative forms, specific embodiments have been described by way of example in detail herein. However, it should be understood that the present disclosure is not intended to be limited to the particular forms disclosed. Rather, the present disclosure is to cover all modifications, equivalents, and alternatives falling within the scope of the present disclosure as defined by the following appended claims and their legal equivalents.

We claim:

1. A pesticidal composition comprising at least one nonionic surfactant and an active ingredient group alpha (AIGA) compound, wherein the weight ratio of nonionic surfactant to AIGA compound is at least about 20:1.

2. The pesticidal composition of claim 1, wherein the weight ratio of nonionic surfactant to AIGA compound is at least about 25:1.

3. The pesticidal composition of claim 1, wherein the weight ratio of nonionic surfactant to AIGA compound is between about 100:1 and 20:1.

4. The pesticidal composition of claim 1, wherein the weight ratio of nonionic surfactant to AIGA compound is between about 65:1 and 20:1.

5. The pesticidal composition of claim 1, wherein the AIGA compound comprises at least one of the following compounds:
an insecticide comprising acephate, acetamiprid, aldicarb, aldoxycarb, bendiocarb, butocarboxim, carbaryl, cartap hydrochloride, demeton-S-methyl, dimethoate, flonicamid, formothion, heptenophos, imidacloprid, isazofos, methamidophos, methomyl, monocrotophos, nitenpyram, omethoate, oxamyl, oxydemeton-methyl, phorate, sulfoxaflor, thiacloprid, thiamethoxam, thiocyclam hydrogen oxalate, thiometon, thiometon sulfone, triazamate, or vamidothion; and
a fungicide comprising carboxin, cymoxanil, dodine, ethirimol, fosetyl-aluminum, fuberidazole, hymexazol, iprobenfos, metalaxyl, metalaxyl-M, metsulfovax, ofurace, oxycarboxin, propamocarb hydrochloride, pyroquilon, or triadimefon.

6. The pesticidal composition of claim 1, wherein the nonionic surfactant comprises a surfactant selected from the group consisting of ethoxylate surfactants, polyglycoside surfactants, polysorbate surfactants, polymeric surfactants, and siloxane alkoxylate surfactants.

7. The pesticidal composition of claim 6, wherein the polymeric surfactant comprises ethylene oxide-propylene oxide (EO-PO) block copolymer.

8. The pesticidal composition of claim 1, wherein the nonionic surfactant comprises a surfactant selected from the group consisting of alcohol ethoxylate surfactants, polyglycoside surfactants, and polysorbate surfactants.

9. The pesticidal composition of claim 1, further comprising at least one of: insecticide, fungicide and herbicide.

10. The pesticidal composition of claim 1, wherein the AIGA compound comprises sulfoxaflor.

11. The pesticidal composition of claim 10, wherein the weight ratio of nonionic surfactant to sulfoxaflor is at least about 20:1.

12. A method of preparing the pesticidal composition of claim 10, wherein the method comprises mixing at least one nonionic surfactant and a sulfoxaflor concentrate, wherein the sulfoxaflor concentrate has a sulfoxaflor concentration of 240 g/L or 500 g/kg.

13. A method of controlling soil-dwelling pest, soil-borne pathogen or both, wherein the method comprises applying a pesticidally effective amount of the pesticidal composition of claim 1 to soil.

14. A method of controlling a sap-feeding insect on a top part of a plant, wherein the method comprises applying a pesticidally effective amount of the pesticidal composition of claim 1 to soil around a root system of the plant.

15. The method of claim 14, wherein the sap-feeding insect comprises a green peach aphid (Myzus persicae).

16. A method of controlling a sap-feeding insect on a top part of a plant, wherein the method comprises applying a pesticidally effective amount of the pesticidal composition of claim 10 to soil around a root system of the plant.

17. A method of controlling pests, comprising:
applying a pesticidally effective amount of a pesticidal composition to at least one of: soil, seed of a plant, a portion of a plant, and locus where control of pests is desired,
wherein the pesticidal composition comprises at least one nonionic surfactant and an active ingredient group alpha (AIGA) compound, and
wherein the weight ratio of nonionic surfactant to AIGA compound is at least about 20:1.

18. The method of claim 17, wherein the weight ratio of nonionic surfactant to AIGA compound is between about 100:1 and about 20:1.

19. The method of claim 17, wherein the nonionic surfactant comprises a surfactant selected from the group consisting of ethoxylate surfactants, polyglycoside surfactants, and polysorbate surfactants.

20. The method of claim 17, wherein the AIGA compound comprises sulfoxaflor.

21. The method of claim 20, further comprising mixing at least one nonionic surfactant with a sulfoxaflor concentrate to provide the pesticidal composition,
wherein the sulfoxaflor concentrate has a sulfoxaflor concentration of 240 g/L or 500 g/kg, and
wherein the pesticidal composition has the weight ratio of nonionic surfactant to sulfoxaflor of at least about 20:1.

22. The method of claim 17, further comprising applying another active formulation to at least one of: soil, seed of a plant, a portion of a plant, and locus where control of pests is desired, wherein the another active formulation comprises at least one of insecticide, fungicide and herbicide.

23. The method of claim 22, wherein the pesticidal composition and the another active formulation are applied at the same time.

24. The method of claim 22, wherein the pesticidal composition is applied before or after the another active formulation is applied.

25. The method of claim 17, wherein the pests comprise a sap-feeding insect.
